(19) United States
(12) Patent Application Publication
(10) Pub. No.: US 2003/0140121 A1
(43) Pub. Date: Jul. 24, 2003

(54) Method and apparatus for access to, and delivery of, multimedia information

(75) Inventor: Jeffrey B. Adams, Belmont, CA (US)

Correspondence Address: Jeffrey B. Adams, Board Member, Intensifi, Inc., 11 Highlands Court, Belmont, CA, 94002, US

(73) Assignee: Intensifi, Inc., a California Corporation, Belmont, CA

(21) Appl. No.: 10/259,535

(22) Filed: Sep. 27, 2002

Related U.S. Application Data
(63) Continuation of application No. 09/560,048, filed on Apr. 27, 2000.
Application No. 09/560,048 is a continuation-in-part of application No. 09/315,924, filed on May 20, 1999, now abandoned.

(51) Int. Cl. G06F 15/16

(52) U.S. Cl. 709/219

(57) ABSTRACT

Some embodiments of the present invention combine two or more separate networks into a unified tool for multimedia information delivery. In particular, the unified tool provides at least an aspect (for example, a visual aspect) of the multimedia information over one of the separate networks and provides at least another aspect (for example an audio aspect) of the multimedia information over another one of the separate networks. In still other embodiments of the present invention, the unified tool provides synchronized multimedia information delivery over the two or more separate networks.

Some embodiments of the present invention enhance the speed of delivery of web content to users. In particular, an embodiment of the present invention is a method for speeding access to web content by a user which includes the steps of: (a) at or prior to display of web content, accessing a list of identifiers of further web content; (b) requesting web content pertaining to at least one of the identifiers before it is actually needed and; (c) optionally, tagging the requested web content with header information which indicates that the requested content will be considered “fresh” for some period of time and not to re-request the web content during its “fresh” time period.

This is a continuation of a patent application entitled “Method and Apparatus for Access to, and Delivery of, Multimedia Information” having Ser. No. 09/560,048 which was filed on Apr. 27, 2000, which patent application is a continuation-in-part of a patent application entitled “Method and Apparatus for Multimedia Information Access” which was filed on May 20, 1999, Ser. No. 09/315,924.

### TECHNICAL FIELD OF THE INVENTION

The present invention pertains to methods and apparatus for access to, and delivery of, multimedia information.

### BACKGROUND OF THE INVENTION

In accordance with prior methods of obtaining information from the Internet, and more particularly the web, a user searches for information, waits for the information to arrive, and then spends a great deal of time reading and trying to understand the information. The cycle then repeats. Because of this, and given current network delays, most web authors create web pages with a great deal of information to offset the user's dislike for the wait the user experiences in obtaining the information. Unfortunately, it can take a great deal of time to fully absorb all the information on these crowded web pages. Further, in large part, the Internet today is very similar to silent movies used early in this century.

Attempts have been made to rework the Internet (and the web) into a fast, multimedia information delivery tool. A first approach in the prior art entails streaming audio and video, which audio and video are delivered over the same network connection as visuals displayed by the user's web browser. A second approach in the prior art entails hosting web presentations at a given time and location; the location being defined, for example, by a web uniform resource locator (“URL”). In accordance with the second approach, the user directs his/her web browser to make a connection with a web server specified by the URL and, upon connection thereto, the user's web browser is “remote-controlled” by the presenter's web server. Next, the user dials into a telephone conference call to hear the presenter's voice while he/she views visuals displayed by the user's web browser that the presenter directs him/her to see.

These two prior art approaches have multiple problems and, because of these problems, they cannot be used effectively to deliver multimedia information to a mass audience. First let us address problenis associated with streaming media such as RealPlayer™ from Real Networks™, MediaPlayer™ from Microsoft™, and Quicktime™ from Apple™. Obtaining multimedia information using streaming media requires the user to download, install and configure a streaming media player. Unfortunately, these steps are normally too much for the average person to deal with, and typically only those skilled in technology are able to complete these steps successfully. The fact that streaming media players are typically pre-installed on new machines does not help the installed base of such players. In fact, statistics show that most software is never upgraded once a machine is installed and in use. In addition, configuring streaming media players for firewalls, i.e., security devices used by business and large organizations, is quite complex. Typically, people give up the installation when they receive the instructions therefor.

Even when a streaming media player is working properly, the quality is less than optimal. For example, periods of silence and odd sounds are common. In addition, the machine on which the streaming media is to be played must have working speakers, a sound card, and enough storage space and CPU capacity to process the streaming media. Additionally, head phones are required to use streaming media in open office environments to avoid disturbing others.

In addition to the above, there are no industry standards for streaming media. As a result, a user might have to download, install, and configure multiple streaming media players if different products and technologies are used by different web sites the user wants to visit. Further, streaming media players are constantly being upgraded, for example, with software updates; and keeping up with the latest update is a daunting task. Still further, due to bandwidth requirements for streaming media, many companies block streaming media on, or from entering, their networks. As one can readily appreciate, all of the above present substantial barriers for a mass audience.

In further addition to the above, another substantial problem for streaming media is raw capacity on the Internet. A simple telephone call guarantees two speakers dedicated capacity of 64 kilobits per second (Kb/s) each. In contrast, the Internet is designed for shared capacity, not dedicated capacity. Although the infrastructure of telephone networks is many orders of magnitude larger than that of the Internet (the Internet only uses something on the order of 8% of the total national telecommunications capacity), not even this large infrastructure can accommodate everyone's talking at once. Quite often one can experience an “all circuits are busy message” when trying to place a telephone call. TCP/IP based networks, like the Internet, were not built for dedicated connections; they are mass access highways where multiple users can all get on at the same time. This contention for the same network is what causes playback problems of gaps and odd noises associated with streaming media.

Second let us address problems associated with hosted web presentation techniques such as NetPodiuM™ from NetPodium™ Inc. and Itinerary™ from Contigo™ software. These techniques require a user to direct his/her web browser to access a specific web server at a specific date and time. Once a connection is made, the user's web browser is remote controlled by the presenter via a Java applet or its equivalent which is downloaded into the user's web browser. The user then dials into a telephone conference call to listen to what the presenter is saying while the presenter causes specific visuals to be displayed by the user's web browser. The primary problem with hosted web presentation techniques is that they require the user to “arrive” at a specific time and place instead of enabling the user to obtain information according to his/her own schedule. A prior art solution to this problem is for the presenter to use streaming audio technology to deliver the presentation to those who could not be available for the original presentation broadcast. We have already described the problems with this streaming media approach above. An additional problem with prior art hosted web presentation technology is that firewalls installed for security purposes can disrupt or block transmission by the hosted web presentation technology. The reason is that an outside entity, the presentation software, reaches into an organization's network from the outside while it is remote controlling the user's web browser. A firewall may interpret this as a break-in attempt and block access to the organization's network. Also, users connected to the presentation over different speed networks may not be kept in proper synchronization with the presentation. For example, a frequently phrase from the presenter while using these products is: “Does everyone have slide XXX on your screen now?”

As one can readily appreciate from the above, a need exists in the art for method and apparatus which enables efficient access to, and delivery of, multimedia information.

### SUMMARY OF THE INVENTION

Embodiments of the present invention advantageously satisfy the above-identified need in the art and provide method and apparatus which enable fast, efficient access to, and delivery of, multimedia information.

Some embodiments of the present invention combine two or more separate networks into a unified tool for multimedia information delivery. In particular, the unified tool provides at least an aspect (for example, a visual aspect) of the multimedia information over one of the separate networks and provides at least another aspect (for example an audio aspect) of the multimedia information over another one of the separate networks. In still other embodiments of the present invention, the unified tool provides synchronized multimedia information delivery over the two or more separate networks.

Some embodiments of the present invention enhance the speed of delivery of web content to users. In particular, an embodiment of the present invention is a method for speeding access to web content by a user which comprises the steps of: (a) at or prior to display of web content, accessing a list of identifiers of further web content; and (b) requesting web content pertaining to at least one of the identifiers.

Another such embodiment of the present invention is a method for speeding access to web content by a user which comprises the step of augmenting web content with date control information when transmitting the web content to the user. In one such embodiment, the step of augmenting comprises augmenting HTTP response headers with the date control information.

### BRIEF DESCRIPTION OF THE FIGURE

FIG. 1 shows a block diagram of a web site that is enhanced by an embodiment of the present invention to provide features that are referred to below as IntenseSound;

FIG. 2 shows a block diagram of a web site that is enhanced by an embodiment of the present invention to provide features that are referred to below as IntenseConference and IntenseChat;

FIG. 3 shows a block diagram of a web site that is enhanced by an embodiment of the present invention to provide features that are referred to below as IntenseDetour;

FIG. 4 shows a block diagram of a web site that is enhanced by an embodiment of the present invention to provide features that are referred to below as IntenseID;

FIG. 5 shows a block diagram of a web site that is enhanced by an embodiment of the present invention to provide features that are referred to below as IntenseSpeed; and

FIG. 6 shows a block diagram of a web site that is enhanced by an embodiment of the present invention to provide features that are referred to below as IntenseSpeedSpiking.

### DETAILED DESCRIPTION

Features of the Present Invention That Will Be Referred to Generally as IntenseSound

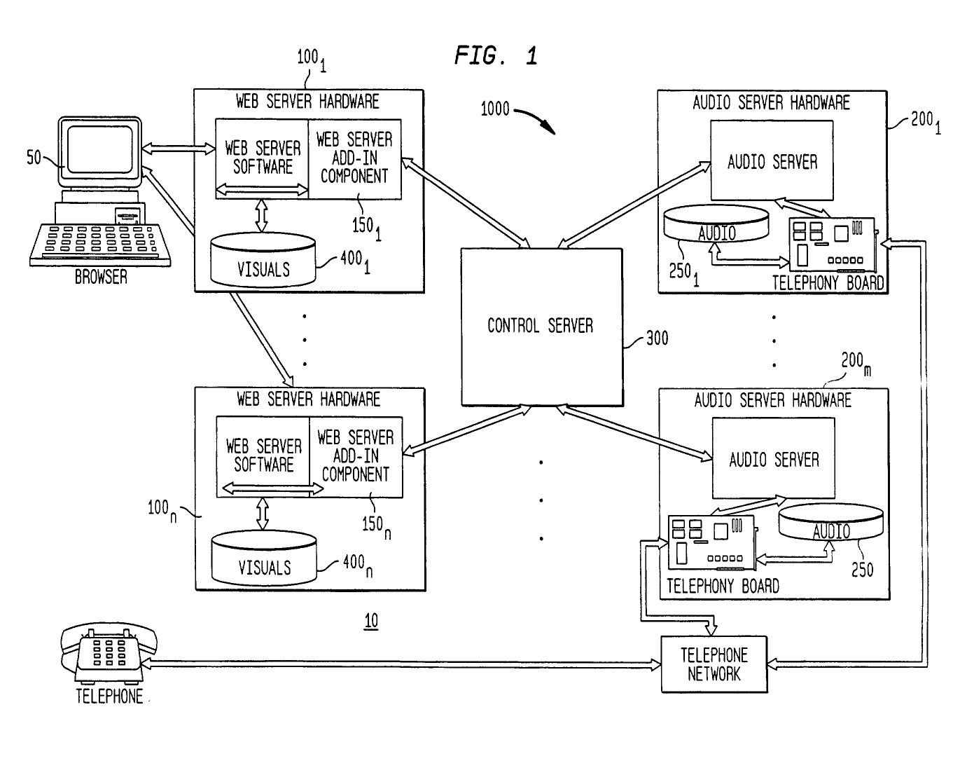

FIG. 1 shows a block diagram of web site 10 that is enhanced by embodiment 1000 of the present invention to provide features that will be referred to below as IntenseSound. As shown in FIG. 1, web site 10 comprises web servers 100₁-100ₙ and embodiment 1000 comprises: (a) web server add-in components 150₁-150ₙ; (b) control server 300 (as will be described in detail below, control server 300 may be one of a number of control servers 300₁-300ₚ, however, for ease of understanding the present invention and without loss of generality, embodiment 1000 will be described in terms of a single control server 300); and (c) audio servers 200₁-200ₘ. As further shown in FIG. 1, embodiment 1000 further comprises visuals 400₁-400ₙ (visual information) that are stored as files on storage devices which are accessible by the respective ones of web servers 100₁-100ₙ. As still further shown in FIG. 1, each of web servers 100₁-100ₙ comprise: (a) web server software or have such web server software accessible by the respective one of web servers 100₁-100ₙ (such web server software is well known to those of ordinary skill in the art, some examples of which are Netscape, MS IIS, Apache, and so forth) and (b) an associated one of web server add-in components 150₁-150ₙ or have such associated one of web server add-in components 150₁-150ₙ accessible by the respective one of web servers 100₁-100ₙ. It should be clear to those of ordinary skill in the art, although web server add-in components 150₁-150ₙ are shown in FIG. 1 to be modules that are co-located in a hardware configuration with associated ones of web servers 100₁-100ₙ for ease of understanding the present invention, the present invention is not thusly limited. As yet still further shown in FIG. 1, each of audio servers 200₁-200ₘ contain one or more telephony boards wherein each of said telephony boards is comprised of ports which can access a telephone network. There are many apparatus which are well known to those of ordinary skill in the art for fabricating the telephony boards and the audio storage utilized to fabricate embodiments of the present invention. Further, as will be readily appreciated by those of ordinary skill in the art, the telephone network can be any telephone network such as the public telephone network, a private telephone network (including a private line) or a combination of such telephone networks. Still further, the telephone network includes all present technology utilized for providing telephone signals, including the Internet or an Intranet. Thus, it should be understood that whenever the term audio is used, the term is used in the most general sense. As such, the term audio refers to audio over telephone or audio over VoIP or audio over whatever technology is available (for example, and without limitation computerized telephony). For example, VoIP can use the H.323 protocol which is well known to those of ordinary skill in the art or any other VoIP technology. Thus, any of these technologies can be used to provide audio (such as synchronized audio), for example, over a computer network (for example, the Internet, a LAN, an Intranet and so forth) as well as over a telephone network. In this sense, the term telephone network includes any network, including a computer network.

Lastly, each web page that is accessible by a user web browser 25 (or other software) running on user web site interface 50 comprises inventive interface software, for example, a Java applet (or its equivalent) and/or JavaScript (or its equivalent), that enables the user to access the inventive functionality provided by embodiment 1000. It should be understood that user web site interface 50 may be any user-web site interface apparatus or appliance that enables interaction between the user and a web site.

It should be clear to those of ordinary skill in the art that embodiments of the present invention can be scaled to support requirements of large commercial web sites and Internet Service Providers (ISPs). In particular, these types of web sites typically use several web servers, for example, web servers 100₁-100ₙ, to support the large number of potential web visitors they might receive. Further, in accordance with other embodiments of the present invention, to support ISP or service bureau configurations, inventive audio servers 200₁-200ₘ can be shared by multiple control servers 300₁-300ₚ. Advantageously, this enables an ISP to set up a bank of audio servers which can be used by any of their clients' web servers as needed. Still further, when web visitors are directed to web servers 100₁-100ₙ that comprise such a the web site, in accordance with a preferred embodiment of the present invention, a single telephone connection between embodiment 1000 and the user is used no matter to which of web servers 100₁-100ₙ the user is directed. This is advantageous because it eliminates having to disconnect and reconnect each time the user is directed to a web server that manages a different section of an organization's overall web site. In accordance with the further embodiments of the present invention, this is accomplished by having all web servers 100₁-100ₙ and, in particular, inventive web server add-in components 150₁-150ₙ, in the web site, coordinate their activities with control server 300 for specific activities in a manner which will be described in detail below.

Additionally, in accordance with one embodiment of the present invention, in order to prevent disruptions or outages that can be caused by congested networks, the inventive web server add-in components 150₁-150ₙ, control server 300, and audio servers 200₁-200ₘ can be connected to primary and secondary networks for communication. In accordance with this embodiment of the present invention, the primary network is normally private to the inventive components and is implemented using high-speed networking technology that is well known to those of ordinary skill in the art. In the event that the primary network is unavailable, the secondary network (if installed) will be used.

Lastly, in accordance with one embodiment of the present invention, in order to be able to perform maintenance or capacity increases without shutting down, the inventive components are re-configurable and expandable while in operation. In accordance with this embodiment of the present invention, operational parameters are changed online through the use of read-write wave locks. As a result, web servers and audio servers can be added while the entire system is up and running.

Reading and writing/updating occur in “waves” one after the other (i.e., read-write-read-write, etc.). Updates must only occur when exclusive access has been granted (i.e., no other readers' or writers'—write wave), but multiple reads can occur simultaneously without conflict (read wave). However, if a read request arrives while a write is pending, the read will wait until the next read wave begins. Additionally, pending write operations will wait until the next read wave is over. Write waves are very short in duration, while read waves can be extremely long lived as long as no write operation is pending. Many methods for implementing the above-described “waves” are well known to those of ordinary skill in the art.

As shown in FIG. 1, and as will be described in detail below, audio servers 200₁-200ₘ play audio files stored on storage devices that are accessible by the respective audio servers 200₁-200ₘ such as, for example, local storage devices 250₁-250ₘ. In a preferred embodiment, a raid array storage device which is well known to those of ordinary skill in the art is used for optimum performance, which raid array has its stripe size set at the same size as a computer telephony board's transfer segments of audio files for playback. Further, it is preferred to store the audio files in an encoding format appropriate for use with the particular computer telephony board in use, for example, Natural Microsystems, Dialogic, and so forth. In the preferred embodiment, audio servers 200₁-200ₘ are configured for as many ports and boards as will fit into a system chassis and not exceed its electrical or thermal recommendations.

Additionally, in accordance with one embodiment of the present invention, audio servers 200₁-200ₘ can also be configured with private ports. These ports are not in a “pool” made available to control servers 300₁-300ₚ for use when users request connections. Rather these ports are reserved for private dial-in access. These ports are dialed into directly by the user, for example, an employee of the company using web site 10. In accordance with this embodiment of the present invention, once connected, the user enters his/her user/visitor ID (previously sent to his/her web browser during a standard connection attempt) on the telephone keypad. If an audio server is shared among multiple control servers (service bureau configuration), the user enters the control server ID and an asterisk (*) or pound (#) on the telephone keypad before his/her user/visitor ID. Once connected, the audio server notifies control server 300 of the connection. Control server 300 then notifies all web servers in the group controlled by the control server of the new connection. At this point, the user is able to visit any audio enabled section of the web site and invoke all of the inventive features. The private port functionality is intended for use by individuals who must always be able to receive inventive audio functionality, whether or not any standard ports are currently available.

In accordance with the present invention, the web server add-in component(s), the control server(s), and the audio server(s) are background processes and/or threads that wait for incoming requests or events and process them accordingly. Additionally, they all read configuration information (to be described in detail below) at startup for subsequent processing. Since much of these operations are common, a preferred embodiment of the present invention places common functions in libraries which are shared by all components, and thus do not need to be re-implemented and maintained as separate source code.

It should also be noted that control servers like control server 300 shown in FIG. 1 need not be co-located with web server hardware 100₁-100ₙ and need not be co-located with audio servers 200₁-200ₘ. They merely need to be accessible to each other. Thus, in accordance with one embodiment of the present invention, inter-component messages (for example, among web servers, control servers, and audio servers) travel over a different/dedicated connection from other network traffic; various intercomponent message protocols will be described in detail below. In accordance with one embodiment of the present invention, all server components combine into a single application/web server add-in component, i.e., the web server add-in component, the control server and the audio server are embodiment as one piece of software.

Although embodiments of the present invention are described in terms of a user software interacting with a web-based system, the present invention is not limited thereby. In fact, in accordance with the present invention, user software may interact with embodiments of the present invention using any one of a large number of front end applications that are well known to those of ordinary skill in the art such as, for example and without limitation, a web-based system, an e-mail based system, or a front-end software package (such as, for example, and without limitation, a linkable software library included in the front-end software package or a specification of the control server “wire” protocol, for example, the protocol used for communication between a web server add-in component and a control server and for communication between a control server and an audio server (this “wire protocol is used to interact with and direct control servers), directly implemented in the front-end software package) that is embedded in a software application.

In accordance with one embodiment of the present invention that is not limited to a web-based system, visual content of an inventive multimedia presentation is e-mailed to the user in accordance with any one of a number of methods that are well known to those of ordinary skill in the art (note that, for such an embodiment, the user does not need to use a web browser to access the multimedia presentation). For example, the multimedia presentation may be e-mailed to the user by a web server add-in component or, for example, and without limitation, by a traditional mail server sending a pre-prepared e-mail). In accordance with this one embodiment, the user receives an e-mail message that contains the multimedia content (for example, visuals), and a “button” or any other indicator, audio or visual (all of which are well known to those of ordinary skill in the art), that is used to initiate associated audio. Whenever the user initiates replay of the multimedia content by, for example, clicking a mouse over the “button” or positioning the mouse over the “button,” the e-mail system accesses a control server/audio server combination (using the control server wire protocol, and starts to play (i.e., display) the visual content. Once audio transmission begins, the multimedia presentation produced is the same as if the user had accessed the multimedia presentation using a web browser (as is described in detail below), referring to coordination of commands, and so forth. Users can follow embedded visual cues in the e-mail message to help them navigate the multimedia presentation sent to the e-mail client, which embedded visual cues, in turn, will cause appropriate audio to be played by sending requests to a control server (using the control server wire protocol). In response, the control server will forward the request to the appropriate audio server. Other visual cues embedded in the visual content may trigger various commands (louder, quieter, mute, advance, rewind, etc.) to be sent to the control server (using the control server wire protocol), which control server will forward the commands to the audio server for execution.

In accordance with another embodiment of the present invention, an inventive front-end package is placed into a software application, which front-end package does not require a web browser or an e-mail client to run. Advantageously, in accordance with this embodiment, training and/or support information in the form of a multimedia presentation can be embedded into the software application directly. For example, a computer aided design application could provide a “button” (in the most general sense discussed above) for a tutorial on a specific topic. Once started, this tutorial would contact a control server (using the control server wire protocol) which, in turn, would contact an audio server to playback audio that is coupled with visuals presented by the design application. The coordination of commands and audio is carried out in the same manner described above with respect to the embodiment utilizing e-mail.

It should be understood that in accordance with embodiments of the present invention, multimedia presentations are directed by software that executes in a user's environment. Thus, the interactive inventive capability of controlling multimedia presentations wherein, for example, a visual portion of a multimedia presentation is provided over a first logical connection channel and, for example, an audio portion of a multimedia presentation is provided over another logical connection can be provided in the user environment in any form such as, and without limitation, a browser plug-in, Javascript, Java, ECMAScript, VB Script, ActiveX, linked in software library or controlled directly in the front-end application by allowing the front-end application to use the control server “wire” protocol (the protocol used to interact with and direct control servers), and so forth. Further, as will be described in more detail below, embodiments of the present invention can be provided in the web server environment in any form such as, and without limitation, Assembler, C/C++, Basic, a Java Application, a Netscape NSAPI module, a Microsoft ISAPI module, an Apache module, and so forth which can be packaged in multiple formats such as, and without limitation, ActiveX controls, native runtime environments, and so forth.

In order to invoke features of web-based embodiments of the present invention, a user navigates web site 10 which has been enhanced by embodiment 1000. Web site 10 will display audio enabled pages and, by invoking features of embodiment 1000, audio specific to the page will be played over a telephone connection (an actual telephone connection or a similar equivalent including, but not limited to, a cell phone telephone connection, a cordless telephone connection, a speaker phone telephone connection, a Voice over Internet Protocol (VoIP) telephone connection, and so forth). Although this embodiment of the present invention (for ease of understanding) is described in a context wherein visual content is received by accessing a web site and audio content is received by accessing audio servers using telephone connections such as telephone lines, this context is not meant to limit the scope present invention. In fact, the present invention includes embodiments wherein e-mail clients and software applications are used to present visual content and computerized telephony such as VoIP technologies are used to receive audio content.

A user's request to initiate an audio connection with web site 10 entails accessing a web page with an embedded form, for example, a Hyper Text Markup Language (“HTML”) page or form. After the user has completed the form, for example, by requesting a connection for a dial-in or dial-out connection, the user invokes the HTML form's submit action. The submit action can be real, or it can be derived from another user action such as the user's selecting (“clicking”) on an item on the page. In accordance with one embodiment of the present invention, if the user has never invoked inventive features of embodiment 1000, the one of web server add-in components 150₁-150ₙ that is associated with the one of web servers 100₁-100ₙ with which the user's web browser is interacting (the “originating web server”) requests the assignment of a user/visitor ID, for example, a 32-bit numeric value, from control server 300. The one of web servers 100₁-100ₙ with which the user's web browser is interacting (the “originating web server”) returns the user/visitor ID to the user's web browser, for example, but not limited to, the form of an HTTP “cookie.” Later, the user's web browser can send the user/visitor ID with subsequent interactions to identify the user making the request. In accordance with one embodiment of the present invention, user/visitor IDs are specific to a group of web servers, for example, web servers 100₁-100ₙ, and are controlled by the one of control servers 300₁-300ₚ that controls web servers 100₁-100ₙ. In a preferred embodiment of the present invention, the user/visitor ID is generated using the TCP/IP domain name (DNS) of control server 300 and that of one of web server add-in components 150₁-150ₙ as a “key” to the user/visitor ID cookie returned to the user's web browser. In accordance with a preferred embodiment of the present invention, the user/visitor ID is a long-lived cookie; for example, one that is set to expire in late 2037. Then, after the user/visitor ID is verified by control server 300, the user's request is sent to one of audio servers 200₁-200ₘ of embodiment 1000.

Further, in accordance with another embodiment of the present invention, call authentication (for example, using an access code) is provided by means of a web-provided authentication code in accordance with any one of a number of methods that are well known to those of ordinary skill in the art. Then, in accordance with this embodiment of the present invention, the user authenticates who he/she is by means of the access code given to him/her by, for example, using a web browser. The access code can be generated by either the audio server, control server or web-server add-in components, the choice of which is installation dependent.

Embodiments of the present invention can be configured in a dial-out and/or a dial-in mode, i.e., to dial the user and/or to have the user dial, respectively. In an embodiment of the present invention where embodiment 1000 dials the user (dial-out mode), the one of web servers 100₁-100ₙ with which the user's web browser is interacting (the “originating web server”) prompts the user for his/her direct dial telephone number. In a preferred embodiment, this telephone number is remembered by the user's web browser, for example, in the form of an HTTP cookie for subsequent usage. In accordance with one embodiment of the present invention, one of audio servers 200₁-200ₘ (the “interaction audio server”) checks that the telephone call is completed within a predetermined time period or it will give the telephone line to someone else. Further, if the one of audio servers 200₁-200ₘ (the “interaction audio server”) determines that no telephone lines are currently available, the one of web servers 100₁-100ₙ with which the user's web browser is interacting (the “originating web server”) so notifies the user, or if the one of audio servers 200₁-200ₘ (the “interaction audio server”) determines that the user's telephone number is disallowed, the one of web servers 100₁-100ₙ with which the user's web browser is interacting (the “originating web server”) so notifies the user. In the case where no telephone lines are currently available, the user is given an opportunity to wait for an available telephone line. This capability depends on whether embodiment 1000 is configured to “wait” on a web site basis or on a customized user basis. In accordance with one embodiment of the present invention, the inventive embodiment can, if no lines are available in dial-out mode, have the audio server keep a list of those to call if a line frees up within a configurable time window. When telephone lines are available for the call, the one of web servers 100₁-100ₙ with which the user's web browser is interacting (the “originating web server”) gives the user an “Access Code” to enter on the telephone keypad when the call is completed. One of audio servers 200₁-200ₘ (the “interaction audio server”) uses this Access Code to verify that the call is connected to the desired recipient. If there is no verification, the one of audio servers 200₁-200ₘ (the “interaction audio server”) will free the telephone line for use by another. In a preferred embodiment of the present invention, control server 300 or audio server 200 randomly generates this Access Code (for example, a number from 10 to 999) and transfers it to the one of web servers 100₁-100ₙ with which the user's web browser is interacting (the “originating web server”). In alternative embodiments, the user automatically supplies a code such as for example, the user/visitor ID which is recognized by the one of audio servers 200₁-200ₘ (the “interaction audio server”). Other embodiments include the use of other methods and apparatus for this verification, including, voice recognition method and apparatus, to perform this “handshake.” In accordance with a preferred embodiment, the user is given three tries to enter the correct Access Code. If the entry is not correct by the third try, the one of audio servers 200₁-200ₘ (the “interaction audio server”) disconnects the telephone line to make it available for reuse. Once the call is connected and the correct Access Code entered, the one of audio servers 200₁-200ₘ (the “interaction audio server”) gives the user instructions over the telephone on how to use the inventive features and how to disconnect when done. In dial-out mode, a waiting list can optionally be enabled for the case when the user wants an audio connection, but no telephone lines are currently available, or when telephone lines are available but a disability in the telephone network makes it impossible to use at least some of the telephone lines.

In an embodiment of the present invention where the user dials embodiment 1000 (dial-in mode), the one of web servers 100₁-100ₙ with which the user's web browser is interacting (the “originating web server”) gives the user a telephone number to dial; which telephone number is for a telephone line that connects to one of audio servers 200₁-200ₘ (the “interaction audio server”). In accordance with one embodiment of the present invention, the one of audio servers 200₁-200ₘ (the “interaction audio server”) checks that the telephone call is completed within a predetermined time period or it will give the telephone line to someone else. Further, if the one of audio servers 200₁-200ₘ (the “interaction audio server”) determines that no telephone lines are currently available, the one of web servers 100₁-100ₙ with which the user's web browser is interacting (the “originating web server”) so notifies the user, or if the one of audio servers 200₁-200ₘ (the “interaction audio server”) determines that the user's telephone number is disallowed, the one of web servers 100₁-100ₙ with which the user's web browser is interacting (the “originating web server”) so notifies the user. When telephone lines are available for the call, the interaction is the same as was described above for the dial-out mode.

In accordance with a preferred embodiment of the present invention, control server 300 tracks which users are connected to which telephone line on which of audio servers 200₁-200ₘ and the state of each such connection. In particular, control server 300 tracks at least the following for each user: (a) a state for each user keyed by user/visitor ID and (b) the identity of the audio server and audio server port, i.e., port on a computer telephony board, that is associated with the user. In addition, control server 300 acts as a clearing house for commands, requests and connection states, i.e., whenever a request arrives at embodiment 1000 that entails use of one of audio servers 200₁-200ₘ, it is forwarded to the appropriate one of audio servers 200₁-200ₘ for processing by control server 300. In accordance with this embodiment of the present invention, audio servers 200₁-200ₘ do not track connections by user/visitor ID, instead, they track connections by port number (board/port combination to support multiple computer telephony boards in a single system). As a consequence, control server 300 tells the audio server to which port the command relates. This simplifies the information tracked by audio servers 200₁-200ₘ. In addition, control server 300 tracks, in real time, the number of available ports on each connected audio server. To do this, audio servers 200₁-200ₘ constantly notify control server 300 when changes in available port counts occur. Thus, when a connection request comes in, control server 300 routes it to the least busy (percentage-wise) of audio servers 200₁-200ₘ. Other embodiments allow a given audio server to be utilized fully before additional audio servers are used by the control server. This choice is installation dependent.

Embodiment 1000 can be configured for use on the public telephone network (PSTN) for external usage or for use on internal organizational telephone networks or for use of any telephone technology such as, for example and without limitation, VoIP technology. This is specified by configuration choice in a manner that is described in detail below. The primary effect of this configuration choice is the size of the telephone numbers users must use, for example, but not limited to, ten digits (area code and phone number for the U.S. and surrounding countries) or some smaller number of digits representing an internal extension or a computer identifier, for example, but not limited to, a TCP/IP address (123.100.90.10) or a hostname (audio1.company.com) for a VoIP connection.

In accordance with one embodiment of the present invention, if the user has not requested an audio enabled page for more than a specified time period, the one of audio servers 200₁-200ₘ (the “interaction audio server”) will warn the user that the call will be disconnected. If the user still does not use another audio enabled page, the one of audio servers 200₁-200ₘ (the “interaction audio server”) will disconnect the telephone call so that another user may use the telephone line.

Additionally, the user may hang-up the telephone call at any time. The one of audio servers 200₁-200ₘ (the “interaction audio server”) will detect this, and make the telephone line available for use by another user. The one of audio servers 200₁-200ₘ (the “interaction audio server”) will send a message to control server 300 that the user is no longer connected. In turn, control server 300 will send a message to all of the web server add-in components 150₁-150ₙ that are associated with the one of web servers 100₁-100ₙ with which the user's web browser is interacting (the “originating web server”) that the user is no longer connected. If control server 300 has been configured to allow users to wait for available telephone lines when no lines are initially available, control server 300 will consult the list of waiting users to determine whether it should use the now available telephone line to place a call to a waiting user. Control server 300 will only cause a telephone call to be made by one of audio servers 200₁-200ₘ to a waiting user if the maximum time period the user specified when it began waiting has not been exceeded. If the time period has not been exceeded, one of audio servers 200₁-200ₘ dials the user's telephone number. If the time period has been exceeded, control server 300 removes the user from the waiting list with no further action.

In accordance with one embodiment of the present invention, a web site augmented with apparatus 1000 can utilize multiple telephone lines from different vendors, and can chose among them. For example, a call that is destined for the same area code as that of an audio server would use lines from a local telephone company, whereas a call that would be out of the area for the user's telephone connection can directed to a predetermined one of long distance telephone companies as determined by the web site operator or in accordance with a preference algorithm that determines the lowest cost in accordance with any one of a number of methods that are well known to those of ordinary skill in the art or to computerized telephony over the Internet. In accordance with this embodiment of the present invention, the use of multiple telephone lines may be indicated by user input when a presentation is made, or it may be configured as part of user identification and used thereafter.

Note that in accordance with one embodiment of the present invention control server 300 and audio servers 200₁-200ₘ can be configured for allowed and disallowed telephone numbers (such configuration is described in detail below). If allowed telephone numbers are used, only telephone numbers in the list can be used with embodiment 1000. If disallowed telephone numbers are in use, all connection requests are checked against the list before being processed. In accordance with this embodiment of the present invention, allowed telephone numbers can be specified for area codes, prefixes, country codes, complete numbers, area code/prefix combinations, and predetermined algorithms (for example, an algorithm that, for example, and without limitation, takes into account the previous factors as well combinations thereof with the time of day) and disallowed telephone numbers can be specified for area codes, prefixes, country codes, complete numbers, area code/prefix combinations, and predetermined algorithms (for example, an algorithm that, for example, and without limitation, takes into account the previous factors as well combinations thereof with the time of day). These allowed and disallowed telephone numbers may be specified in configuration files for control server 300 and audio servers 200₁-200ₘ (such configuration files are described in detail below) or they may be updated in accordance with any one of a number of methods that are well known to those of ordinary skill in the art. Audio servers 200₁-200ₘ forward their allowed and disallowed number lists to the associated one of control servers 300₁-300ₚ so that the associated control server, for example, control server 300, can determine which one of audio servers 200₁-200ₘ to select for new connections based on loading considerations and whether or not the one of audio servers 200₁-200ₘ will dial the number or not based on its allowed and disallowed telephone numbers. Control server allowed and disallowed telephone number lists are consulted first, then the appropriate audio server allowed and disallowed telephone number lists are consulted. If the call is allowed, the connection will continue. If the user's telephone number is not allowed, the user will be notified as such. Normally, when audio servers are dedicated to a single control server, allowed and disallowed telephone numbers are not specified at the audio server level; rather they are specified at the control server level.

In accordance with a preferred embodiment of the present invention, each audio enabled web page includes command buttons (designed by web page authors using any one of a number of methods that are well known to those of ordinary skill in the art) that are represented, for example, as HTML links, which command buttons can be used to invoke a number of commands. Such commands are, for example: (a) pause the audio; (b) play the audio (after a previous pause command); (c) restart the audio (and optionally animated graphics on the web page); (d) increase the volume; (e) lower the volume; (f) mute the audio (web page continues to animate, but without sound); (g) un-mute the audio (cancel a previous mute command); and (h) optionally to: (i) rewind 5, 10, 15 or any number of seconds; (ii) advance 5, 10, 15 or any number of seconds; (iii) increase the playback speed; (iv) decrease the playback speed; (v) record a message to be forwarded to appropriate personnel (the message being recorded using audio servers 200₁-200ₘ in accordance with methods that are well known to those of ordinary skill in the art); and (vi) request to be connected to a “live” person as needed. In accordance with further embodiments of the present invention, audio can be muted at any time by pressing, for example, any key on a telephone keypad. However, this will not stop any visual animation that may be occurring on a web page. Further embodiments include stopping visual animations when a predetermined telephone keypad key is pressed, if possible, for a particular visual animation. Still further, the web designer can include command buttons for “play or set audio file” commands to request that a requested audio file be: (a) played immediately (by canceling the playback of any currently playing audio file); (b) played immediately after the current audio file finishes playing; (c) set for play after the current file finishes playing (requires play command to actually start the “set” audio playing); and (d) set for play and stop the currently playing file (requires play command to actually start the “set” audio playing). As one can readily appreciate “set” commands are useful in the case of a menu where replaying the same audio file each time the menu is visited would become annoying to the user.

In addition to the above control functions, in accordance with one embodiment of the present invention, a user can cause the audio and/or animated visuals to be sped-up or slowed-down based on user input received using command buttons appearing, for example, in visual presentations or using predetermined keypresses associated with a telephony logical connection (of course it should be understood herein that whenever one discusses an interaction using telephony capabilities such as a keypad of a telephone this also refers in the general sense to input over a telephony logical connection using any telephony technology) or entering voice input using the telephony logical connection (which voice input is interpreted using any one of a number of voice recognition methods that are well known to those of ordinary skill in the art). In accordance with this embodiment, and as described herein, user input resulting from the use of command buttons is routed in the first instance through web server add-in components, and user input resulting from the use of the telephony connection is routed in the first instance through audio servers. In response to such requests, the audio may be played using any one of a number of time scale modification methods that are well known to those of ordinary skill in the art, which methods are implemented, for example, in the audio servers. In addition, the animated visuals may be presented using any one of a number of methods that are well known to those of ordinary skill in the art for frame adjusting any animated visual to provide synchronization with the speed of the audio (if requested). As is well known, as the audio is sped-up or slowed down, the visuals need to be adjusted. If a speed-up or slow down request is originated by user interaction with visual content (for example, and without limitation, by interaction with a web server side of an embodiment of the present invention, illustratively, web browser to web server add-in component), then code (for example, HTML, Javascript, and so forth) running in the user's interaction application will adjust its playback rate. If, however, the speed-up or slow down request is originated by user interaction with an audio connection (for example, and without limitation, by interaction with a telephony side of an embodiment of the present invention, illustratively, web browser to audio server), then the amount of the speed-up or slow down requested is communicated back (through the control server and the web server add-in component for a web site based embodiment) to the user interaction application running the visuals (for example, and without limitation, a web browser) so they can then also be sped up or slowed down. Advantageously, in accordance with this embodiment, users with disabilities can be supported by enabling them to set the audio to be louder or quieter as needed. Additionally, a particular audio level may be determined by user input when a presentation is made, or it may be configured as part of a user identification and a predetermined setting will be used when a presentation is provided to the particular user.

In addition to the above control functions, in accordance with one embodiment of the present invention, a user can cause the audio and/or visuals to be presented in a desired target language, or to have verbalized audio (spoken, sung, and so forth) rendered by a predetermined one of different people based on user input received using command buttons appearing, for example, in visual presentations, or using predetermined keypresses associated with a telephony logical connection, or entering voice input using the telephony logical connection (which voice input is interpreted using any one of a number of voice recognition methods that are well known to those of ordinary skill in the art). In accordance with this embodiment, and as described herein, user input resulting from the use of command buttons is routed in the first instance through web server add-in components, and user input resulting from the use of the telephony logical connection is routed in the first instance through audio servers. In response to such user input, the audio content may be played from one of a set of different language audio presentations, or from one of a set of audio presentations from different people, which set of different language audio presentations are stored so as to be accessible to the audio servers (i.e., stored in a database at the audio servers or stored in a database accessible to the audio servers), and the visual content may be played from one of a set of visual presentations, which set of visual presentations are accessible to web servers 100₁-100ₙ) (i.e., stored in a database at a web server or stored in a database accessible to the web server). Additionally, a particular target language and/or a particular person's presentation may be determined by user input when a presentation is made, or it may be configured as part of a user identification, and a predetermined setting will be used when the presentation is provided to the particular user. Further, in addition, this capability can be used to provide predetermined presentations for predetermined classes of users. In accordance with this aspect of the present invention, user identification profiles can be configured to provide such a capability.

In addition to the above-described control functions, in accordance with one embodiment of the present invention, a user can cause a copy of audio to be made based on user input received using command buttons appearing, for example, in visual presentations, or using predetermined keypresses associated with a telephony logical connection, or entering voice input using the telephony logical connection (which voice input is interpreted using any one of a number of voice recognition methods that are well known to those of ordinary skill in the art). In accordance with this embodiment of the present invention, any one of a number of voice recognition methods that are well known to those of ordinary skill in the art can be used to create a transcript of the audio. In accordance with this embodiment, and as described herein, user input resulting from the use of command buttons is routed in the first instance through web server add-in components, and user input resulting from the use of the telephony logical connection is routed in the first instance through audio servers. In response to such user input, a copy and/or a transcript is made of everything the user has heard, and optionally everything the user has said. The copy may be created and stored in a file or files in one or more databases that are accessible to the audio server, and the transcription may be created using processing power associated with the audio server, or a copy of the audio may be transmitted to a remote system for creation of the transcription thereat. In either case, the resulting copy may be transmitted to the user, for example, at a predetermined voice mail address, the transcription may be delivered to the user, for example, at a predetermined e-mail address, or the user may access the copy or the transcription directly by accessing the system (the audio server or the remote system) for delivery. In addition to the above, an audio portion (for use with embodiments of the present invention) can be created by typing text into a file, and then transmitting the file to the embodiment using configuration commands. Then, the text is turned into speech using any one of a number of text to speech (TTS) methods that are well known to those of ordinary skill in the art, for example, using processing power at an audio server, or using processing power at a system accessible by an audio server. In this configuration, user input is received to cause the “spoken text” to be associated with visuals for a multimedia presentation. Thus, instead of actually recording audio with a microphone, text is created using, for example, a keyboard, and the text is saved into a file. The TTS system then converts the text in the file into audio that is played over the audio connection. As is well known in the art, TTS systems can even mimic inflection to sound very life-like. The association of a visual and “audio” is made in the manner described herein for the association of a visual and audio. For example, an audio file might be referenced as a file having a name ###.wav whereas an “audio text file” file might be referenced as a file having a name ###.txt. Then, whenever an audio server is requested to play a file having a name ###.wave, it recognizes that it can directly play it. However, whenever an audio server is requested to play a file having a name ###.txt, it recognizes that the file must first be run through a TTS to produce audio.

In accordance with one embodiment of the present invention, a user can cause an existing telephone connection (using any telephone technology such as, for example, traditional telephony or VoIP) to be transferred to another party such as, for example and without limitation, an individual, a voice mailbox, a call center, a call center agent, and so forth. The use of VoIP technology is useful when the connection to the called party would entail setting up a long distance telephone call from an audio server where the cost of the long distance call could be large. A user can invoke this inventive capability based on user input received using command buttons appearing, for example, in visual presentations, or using predetermined keypresses associated with a telephony logical connection (of course it should be understood herein that whenever one discusses the use of an interaction using telephony capabilities such as a keypad of a telephone this also refers in the general sense to input over a telephony logical connection using any telephony technology), or entering voice input using the telephony logical connection (which voice input is interpreted using any one of a number of voice recognition methods that are well known to those of ordinary skill in the art). In using input by means of information transferred using the visual presentation, the user merely invokes, for example, a mouse click over a “command button” to cause the telephone call to be transferred. In accordance with one aspect of this embodiment of the present invention, the user is queried in accordance with any one of a number of methods that are well known to those of ordinary skill in the art to supply a telephone address for the called party. In obtaining the telephone address, the user can be provided with access to a telephone address directory in accordance with any one of a number of methods that are well known to those of ordinary skill in the art to make the selection. After receiving this information, a transfer command, along with the telephone address is transferred to the audio server to effectuate the transfer. In accordance with other aspects of this embodiment, the telephone address is obtained by telephone dialog over the telephone connection with the audio server, which telephone dialog may be carried out in accordance with any one of a number of methods that are well known to those of ordinary skill in the art by providing requests to the user using voice messages transferred to the user from the audio server and receiving data from the user using keypad presses or voice input. In accordance with this embodiment, the called party (i.e., the target of the connection request from the user presently connected to the inventive embodiment, for example, a call center agent) can refuse the call, transfer the call to another person, transfer the call to voice mail while the call is still connecting (from the user's perspective), and so forth. Further, in accordance with this embodiment, the call may be transferred to a wireless device such as, for example, and without limitation, a cell phone. Still further, in accordance with this embodiment, when the transferred call is complete, i.e., whenever the called party hangs-up or is disconnected, or the user wishes to go back to the multimedia presentation session, the transferred call is disconnected, a call is set up to the user, and the multimedia presentation session is resumed.

In accordance with a further aspect of this embodiment of the present invention, a user can transfer an existing call (using any telephone technology such as, for example, traditional telephony or VoIP) to another party wherein the telephone address of the called party is determined by various locations at a web site. For example, and without limitation, a transfer from a sales page portion of a web site may be made to a sales call center; a transfer from a support page portion of a web site may be made to a support call center; and so forth. When the user requests the transfer, the addresses and the functionality are invoked by making, for example, a mouse click over a “command button.” Further, in accordance with this embodiment of the present invention, the telephone address for the transfer can depend on the time of day, the day of the week, vacation or sick status, and so forth. Additionally, the telephone address for the transfer can be obtained from a database of telephone addresses, which database is accessed using a dialog interaction presented on a web page. Additionally, using any one of a number of methods which are well known to those of ordinary skill in the art, the telephone address for the transfer can be embedded in locations of the web site as clear text, or the telephone address for the transfer can be encoded (advantageously this provides security since the user cannot see the telephone address). Still further, in accordance with this embodiment of the present invention, the telephone address for the transfer can be defined at the web server level wherein, for example, a key which references it is included in the web page (in this embodiment a database of telephone addresses is accessible, for example, and without limitation, to the web server add-in components, to the control servers, or to the audio servers). Advantageously, where the key is used to retrieve information from a database accessible to the control server(s), the telephone address is thereby defined in a central location without having to define it on each web server which connects with the same control server.

As described in detail above, in accordance with one embodiment of the present invention, a user can transfer an existing logical telephone connection to a third party, for example, an integrated service fulfillment system at predetermined point of user interaction with a web site. As is well known to those of ordinary skill in the art, many service fulfillment systems have numerous customer interface levels. Advantageously, in accordance with this embodiment of the present invention, a user can be transferred to a specific level in the service fulfillment system (advantageously skipping predetermined interface levels). This is done by invoking the transfer at a predetermined location at the web site, which predetermined location includes a telephone address directly to the specific level in the service fulfillment system. An example of how to use this embodiment of the present invention relates to a stock ordering system wherein user identification information such as, for example, pin, symbol, and so forth is tracked at the web site by the web server in accordance with any one of a number of methods that are well known to those of ordinary skill in the art. In accordance with this embodiment, whenever the user invokes a command button presented on a web page, he/she would be transferred to a stock ordering system (i.e., telephone call would be placed by an audio server in response to commands received from a web server add-in component). When the telephone logical connection is set up, the user might enter, for example, a transaction amount or a credit card number via the telephone logical connection using, for example, a telephone keypad. Advantageously, in accordance with this embodiment of the present invention, the user does not have to key in other information such as, for example, pin, symbol, and so forth because this information was supplied by the audio server when the telephone connection was set up. Further, in accordance with this embodiment of the present invention, integration with call center applications (Siebel, Vantive, etc.) can be provided so that transferred calls will cause screen pops on a call center agent's computer screen as, or before, the telephone call is transferred. The integration entails providing information from the embodiment to the call center application, which information can be stored in databases that are accessible from any of the components of the embodiment.

In accordance with one embodiment of the present invention, a user can cause an existing telephone call to be transferred to audio servers maintained by different organizations. Advantageously, in accordance with this embodiment of the present invention, a user need only place a single call no matter where the user navigates. This transfer can be accomplished in one embodiment using any one of a number of telephone company call transfer methods that are well known to those of ordinary skill in the art such as, for example, using an SS7 message. Alternatively, this transfer can be accomplished by having the user connect to a single audio server, and having audio from different organizations routed to the audio server to which the user is connected using VoIP technology.

As has been described in detail above, in accordance with embodiments of the present invention, a user can navigate a “front end application” (for example, a web-based system, an e-mail based system, or a system that is embedded in an application) using an audio channel integrated with voice recognition capabilities associated, for example, with an audio server. In accordance with these embodiments, the system can utilize a voice print to provide user identification. In addition, in accordance with these embodiments, a user can use an audio channel integrated with voice recognition capabilities associated, for example, with an audio server to make queries or requests via voice/audio, and to have responses to these queries appear in the front end application by causing a search application to obtain responses to the queries, and by causing the front end application to display the responses. Alternatively, the responses could be provided via voice/audio by converting the responses to speech. In accordance with this embodiment, the search application can be queried in accordance with any one of a number of methods that are well known to those of ordinary skill in the art such as, for example and without limitation, database queries over the Internet.

In accordance with one embodiment of the present invention, a user can cause changes in visual content presented based on whether the audio is on or off. For example, in accordance with this embodiment, the user can direct a change in the density of the visual presentation, such as, and without limitation, changing the number of “words” appearing on a web page. The user can direct the use of this capability by, for example, executing a mouse click over a command button when a presentation begins. In accordance with one embodiment of the present invention, an audio server can terminate an audio stream from a user whenever the user is only listening to audio sent by the audio server If the user has established an audio session, but is viewing the no audio version of the web site, then after a predetermined, configurable, amount of time, the user will receive a message referring to the lack of receipt of audio (for example, from an audio server). If the user does not move back to the audio version of the web site, the audio session will be terminated (for example, by the audio server). Advantageously, this embodiment of the present invention conserves network resources, and audio server processing resources.

In accordance with one embodiment of the present invention, multimedia presentations can contain menu items that enable a user to send commands to, for example, a web server add-in component (such commands are processed in the manner described in detail below) to cause the web server add-in component (or a system with which the web server add-in component communicates) to send an e-mail to a designated e-mail address or to a designated list of e-mail addresses. Advantageously, this enables a user to distribute information to a number of targets, such as, without limitation, to colleagues. Further, in accordance with other aspects of this embodiment, the user can send such commands to an audio server using, for example, a telephone keypad to enter information, or using audio input, such as voice input. In such an embodiment, voice recognition methods which are well known to those of ordinary skill in the art may be used to convert the audio input to numerical or coded input. Then, information obtained in this manner can be transferred, for example, to a web server add-in component in accordance with methods that are described in detail below to cause the transmission to an e-mail address or to a designated list of e-mail addresses.

In accordance with a preferred embodiment of the present invention, commands are “issued” by a user's web browser by having it “request” files which map to predetermined commands in a predetermined directory, for example, /isound/commands, on the one of web servers 100₁-100ₙ. with which the user's web browser is interacting (the “originating web server”). Requests to the predetermined directory and its sub-directories are intercepted and processed by the associated one of the web server add-in components 150₁-150ₙ. Advantageously, in accordance with the preferred embodiment of the present invention, the user's web browser merely believes that it is requesting another file to be displayed. In response to the request from the user's web browser, and after processing the request, the one of web servers 100₁-100ₙ. with which the user's web browser is interacting (the “originating web server”) responds to the user's web browser with a “No response necessary” code. Advantageously, in accordance with the present invention, when the user's web browser receives this response code, it continues from where it was when it issued the request without moving to another web page as it normally would whenever it requests a file from a web server. An optional embodiment of the invention only allows commands to be processed if they originate from the same page (location) as the audio file being played or set (see below). This takes into account potential slowness or out-of-order delivery common on shared networks like the Internet. Some commands can be set to be “master” commands. These master commands are processed whether or not they originate from the same page (location) as the audio file being played or set. For example, commands such as louder, quieter, disconnect, and status (and their variants) will be processed no matter when they arrive. In accordance with one embodiment of the present invention, any command can be treated as a master command by pre-pending a predetermined identifier to the command. For example, a command can be treated as a master command by pre-pending an “M” to the command (i.e., pause becomes Mpause).

Thus, in accordance with the present invention, commands like the “play or set audio file” commands are “issued” by, for example, having the user's web browser “request” files which map to audio files, which audio files are played by the one of audio servers 200₁-200ₘ (the “interaction audio server”) with which the user is interacting over the telephone (physical or virtual).

In accordance with the present invention, and as shown in FIG. 1, web server add-in components 150₁-150ₙ are integrated with their associated web servers 100₁-100ₙ and provide files requested by the user's web browser. In particular, web server add-in components 150₁-150ₙ intercept requests for inventive features, which requests for inventive features are actually commands, connection/disconnection requests, or requests for audio files to be played.

Additionally, web server add-in components 150₁-150ₙ may optionally keep a list keyed by user/visitor ID which tracks two connection “states” for each user. The states are “connected” or “connection-in-progress”. This list is updated based on messages being sent to a web server add-in component from an associated control server. Web server add-in components 150₁-150ₙ use this information to determine whether a new request or command is for a user which already has a telephone session enabled or not. If a telephone session has been enabled, the new request or command is passed to control server 300. If a telephone session has not been enabled, the new request or command is ignored. Advantageously, this reduces the burden on control server 300 and keeps traffic at the lowest possible level between server components of embodiment 1000. In other words, play, set and control commands are only processed if the user is in the connected state, i.e., no play, set or control commands are processed if a user is in the “connection-in-progress state.” Further, when in the “connection-in-progress” or “connected,” state the user is not allowed to attempt to establish another session (dial-out mode) or reserve a line (dial-in mode). In some cases the web server does not maintain the state of the user's session, and all commands and requests are forwarded to the control server. In such a case, if the user is connected, the control server processes the request or command. However, if the user is not connected, the control server returns a response back to the web server add-in component indicating this condition.

When web server add-in components 150₁-150ₙ are installed on their associated web servers 100₁-100ₙ, in accordance with a preferred embodiment of the present invention, the Multi-purpose Internet Mail Extension (“mime”) types file of each is augmented to recognize certain file extensions as corresponding to play or set commands of inventive embodiment 1000. For example, in accordance with the present invention: (a) a file extension of is or .ispn maps to “play immediately”; (b) a file extension of .ispl maps to “play after current file”; (c) a file extension of .issn maps to “set immediately” (and abort current audio playback); (d) a file extension of .issl maps to “set after current file finishes playing.” Advantageously, in accordance with the present invention, the user's web browser simply believes it is requesting another file to be displayed. Then, in accordance with the present invention, after processing the play or set command, the one of web server add-in components 150₁-150ₙ sends a message to its associated one of web servers 100₁-100ₙ. with which the user's web browser is interacting (the “originating web server”), and that web server, in turn, sends a “No response necessary” code to the user's web browser. The “no response necessary code” can either be an empty html document (<html></html>) delivered with an HTTP status code of 200 or a null response (HTTP status code 206). By default the web server add-in component will deliver the empty document, but the null document can be returned instead by inserting an N (capital) immediately following the ? (question mark) in HTTP get requests for commands and play/set requests (See below). This dual behavior is necessary as some content creation tools (i.e. Macromedia flash) will attempt to navigate when HTTP response code 200's are received. With HTTP response code 206's, they will not. However, the empty HTML document is the default behavior as some popular browsers (Netscape) will not pay attention to set cookie requests unless the HTTP response code is 200. This Netscape behavior is in violation of the HTTP specification, but it is already widely deployed and thus too late to fix. When the user's web browser receives this response code, it continues from where it was when it issued the request without moving to another web page as would normally be the case whenever it requests a file from a web server.

As one can readily appreciate, embodiments of the present invention can be fabricated wherein a request of a webserver (for example, one of web servers 100₁-100ₙ) is determined to be destined, in actuality, for one of web server add-in components 150₁-150ₙ using a method other that described above (i.e., the use of file extensions via mime types file). In accordance with the present invention, there are many alternatives. The following is intended to provide examples of alternatives, and is not intended to provide an exhaustive list thereof.

1) As one example, the “play now,” “play later,” “set now,” and “set later,” commands are provided as part of a hierarchical “virtual” directory structure embedded in a request (for example, /audio/playnow/filename.ext). In such an embodiment, one of web server add-in components 150₁-150ₙ scans the request to determine if any of the keywords (for example, “playnow”) is embedded therein. If so, the request is recognized as a play or set request directed to the one of web server add-in components 150₁-150ₙ, and the one of web server add-in components 150₁-150ₙ strips, for example, the “/playnow” out of the request before further processing.

2) As another example, the type of the request becomes part of an HTTP condition get request (for example, /directory/subdirectory/filename.ext?playnow).

As one can appreciate from the above, in accordance with these embodiments of the present invention, the objective is to transmit the play or set requests, as well as other commands (for example, pause, eject, and play) using standard HTTP requests, and have these requests be recognizable by web servers 100₁-100ₙ as requests that are actually destined for web server add-in components 150₁-150ₙ. Additionally, the use of the “no response necessary” is generic. Any number of standard HTTP status codes can be “overridden” to achieve the same effect.

The URL of the requested audio file is sent through the one of web server add-in components 150₁-150ₙ that is associated with the one of web servers 100₁-100ₙ. with which the user's web browser is interacting (the “originating web server”) to control server 300, and from there, in turn, to one of audio servers 200₁-200ₘ. In accordance with one embodiment of the present invention, the one of audio servers 200₁-200ₘ (the “interaction audio server”) looks in a directory for audio files that correspond to a control server 300 and the one of web servers 100₁-100ₙ with which the user's web browser is interacting (the “originating web server”). In that specified directory, the one of audio servers 200₁-200ₘ (the “interaction audio server”) uses the same relative file location as that of the original file URL request to the one of web servers 100₁-100ₙ with which the user's web browser is interacting (the “originating web server”). More explicitly, in accordance with this embodiment, the directory structure is replicated between the one of web servers 100₁-100ₙ with which the user's web browser is interacting (the “originating web server”) and the directory on the one of audio servers 200₁-200ₘ (the “interaction audio server”) where audio files for the appropriate one of control server 300 and web servers 100₁-100ₙ are stored. Once the audio file is located in the appropriate directory it is played or set as appropriate. To understand how this works, assume that the user makes a request to play an audio file immediately at a given location. The user's web browser requests the URL “/introduction/intro1.is”. The one of web server add-in components 150₁-150ₙ associated with the one of web servers 100₁-100ₙ with which the user's web browser is interacting (the “originating web server”) detects this as a request for an audio file because of the .is file extension. Next, the associated one of web server add-in components 150₁-150ₙ passes the request to control server 300 which, in turn, passes the requests to one of audio servers 200₁-200ₘ (the “interaction audio server”) where the telephone call is connected. In this example, assume that: (a) the web server ID of the one of web servers 100₁-100ₙ with which the user's web browser is interacting (the “originating web server”) is 12 and (b) the control server ID of control server 300 is 7. Then, in accordance with the present invention, audio servers 200₁-200ₘ were instructed at startup time via a configuration file (in a manner that is described in detail below) to look in the directory “C:\isound\audio\CS7\WS12\” for requests originating from this web server ID/control server ID combination. To handle the above-identified request, the one of audio servers 200₁-200ₘ (the “interaction audio server”) searches that directory for a subdirectory “introduction” and for a file named “intro1” in that subdirectory. If the file exists, the one of audio servers 200₁-200ₘ (the “interaction audio server”) plays it immediately. In accordance with the present invention, the actual file played does not have the .is extension of the original request; instead, it has an extension representing its actual encoding and compression method. Many options exist, but common choices are: (a) .vce for Natural Microsystems computer telephony boards; (b) vox for Dialogic computer telephony boards; and (c) .wav for computer telephony boards which implement the industry standard WAVE format. Thus, in accordance with a preferred embodiment of the present invention, the audio files are encoded in an optimal playback format that is specific to the type of computer telephony board installed. Additionally, many methods are well known to those of ordinary skill in the art for recording or converting audio to these formats, for example, but not limited to, Cool Edit™ from Syntrillium™.

In accordance with the present invention, audio is synchronized with animated visuals that appear on a web page as follows. After all visual page elements have been loaded to the user's web browser, the user requests the appropriate audio file to play. When the request to play the audio file completes, the visuals start animating. In particular, synchronization is accomplished by determining the time at which visuals are to animate. This is done by: (a) noting the time in the audio playback where the specific visual animation is desired and (b) producing a time index for the visual animation in question (relative to, for example, an expected time of commencement of audio playback). Next, JavaScript, VBScript, Java, ActiveX, FLASH or similar language code used for animation (not audio control) which is embedded in the web page is encoded with this time index. Then, the appropriate animation occurs when the time index arrives. As a result, the audio and visuals start at the same time and remain synchronized based on an analysis (for example, by the web page author) as to the precise time index when visual animations are to occur. As a guide to the web page author, audio tracks should include a predetermined period of silence (for example, approximately a half second of silence) at the beginning since the preferred embodiment of the present invention will start playing the audio the moment it is requested (this can be altered to include a predetermined delay, for example, the half second of delay in other embodiments). However, in accordance with the preferred embodiment, the visuals typically will not proceed until the command to play the audio file is complete based on a return from the call to the web server. The predetermined period of silence in the audio file or the predetermined period of delay (for example, the half second) takes into account any potential time delay that might occur between the audio file's starting to play and the web server's returning the “command to play complete” response to the user's web browser (or some desired effect the web page author wishes to create). In a preferred embodiment, for optimal performance, public (Internet) web sites enabled with embodiments of the present invention are connected directly to the Internet backbone in Internet data centers managed by ISP's or at the end of high speed links in organizational data center(s).

In accordance with the present invention, an audio enabled web page has one or more associated audio files. All a web page author need do to cause multiple files to be played for a given web page is to “visit” the corresponding URLs (described above) at the appropriate time indices which will cause the inventive embodiment to play the corresponding audio file.

When a user leaves a web page or minimizes the web browser or shuts down the web browser for which audio is playing, the audio is automatically stopped. One exception would occur when using Microsoft's Internet Explorer (v4.x) browser on an Apple Macintosh computer. In this case, a telephone keypad key must be used to pause any undesired audio playback.

In accordance with one embodiment of the present invention, referred to as a multi-track audio feature of the present invention, a background audio track is played with a foreground audio track, which multi-track feature does not require a recording that pre-mixes the foreground and the background audio tracks ahead of time. In accordance with one aspect of the multi-track audio feature of the present invention, background audio tracks to be played can be selected on, for example, a predetermined basis. In one example where background audio tracks are selected on a predetermined basis, background audio tracks can be selected, or changed, on the basis of algorithms that depend, for example, and without limitation, on a number of criteria such as one or more of a time period such as the day of the week, or the time of the day, or the month of the year, or the season of the year, or a combination of some or all of the above, and so forth. In another example, where background audio tracks are selected on a predetermined basis, background audio tracks can be selected based on user profile which is determined using, or by, user identification. In this mode, whenever a user logs onto the system, a database that stores a user profile is accessed using the user identification, which user profile identifies one or more classes of, or particular ones of, background audio tracks to be played. In this mode, the user profiles can relate to single users, or to class a of users (for example, in some instances differences can be based on country, or part of a country, and so forth). Advantageously, the use of the multi-track audio feature of the present invention provides a personal look and feel to background audio tracks played for the user and, hence, to web page presentations. In accordance with this feature, the decision as to which background audio track is played can be made in, for example, a web server add-in component with the decision being transmitted to an audio server for audio presentation, or, alternatively, the decision can be made by an audio server to which is transmitted the information required to make the decision.

The following summarizes various capabilities that can be provided by embodiment 1000 (which capabilities are referred to collectively as IntenseSound). As was described in detail above, an embodiment 1000 of the present invention enables Synchronized Web Audio Navigation (“SWAN”). As defined herein, SWAN refers to a number of capabilities wherein audio is presented to a user as he/she navigates a web site. Advantageously, in accordance with embodiments of the present invention, SWAN capabilities enable the user to be an active participant in a multimedia web experience. In accordance with embodiments of the present invention, one can provide levels of SWAN wherein each level of SWAN adds functionality to other levels of SWAN.

The essence of SWAN is that events caused by a user's actions can be tracked, and acted upon by the web browser or similar sofwtare application. These events can have actions (for example, IntenseSound client side components) tied to them. The actions (for example, IntenseSound client side components) are software routines that are written in one or more programming languages. A list of exemplary programming languages includes, but is not limited to: HTML, DHTML, JavaScript, VBScript, ActiveX, Java, ECMAScript, and Flash. The actions (for example, IntenseSound client side components) themselves trigger IntenseSound server-side components to perform the required action (play a file, issue a command, etc.). This is done by having the actions (for example, IntenseSound client side components) “visit a URL” in the manner described in detail above. SWAN is predicated on being able to react to events generated in the web browser or similar software application. At present, web browsers can act on the following types of events: page loading complete, mouse click, mouse over, page close, and so forth. This list of event types is not complete (one may consult individual browsers' documentation for complete lists of events). In accordance with embodiments of the present invention, IntenseSound actions can be tied to any or all of these events, as desired.

The following describes several levels of SWAN.

SWAN Level 1: In accordance with a SWAN Level 1 capability (wherein audio is presented to a user as he/she navigates a web site) that is provided by embodiments of the present invention, audio is synchronized with a display of a single web page (page load event). For example, once the web page is rendered on the user's appliance, and a connection is made to an audio server, a predetermined audio sound segment begins to play. In accordance with the SWAN Level 1 capability, the predetermined audio sound segment continues to play until it is completed, regardless of actions taken by the user to move within the web site. Thus, in accordance with the SWAN Level 1 capability, audio is typically synchronized with the beginning of a presentation, and there is no interaction with the user once the presentation starts. It should be clear to those of ordinary skill in the art how to implement the SWAN Level 1 capability in light of the detailed description set forth herein.

SWAN Level 2: In accordance with a SWAN Level 2 capability (wherein audio is presented to a user as he/she navigates a web site) that is provided by embodiments of the present invention, audio is synchronized at a web page level. This means that, a predetermined audio segment is associated with each page presented at the web site (page load event), wherein user action is required to go from one page to another. Thus, in one embodiment of the SWAN Level 2 capability, a presentation is provided wherein the user must click on a next page button or on a designated page button to receive a next designated segment of audio and its associated visuals. Advantageously, such an embodiment may be used to review presentations created, for example, with a RealPresenter plug-in to PowerPoint97. It should be clear to those of ordinary skill in the art how to implement the SWAN Level 2 capability in light of the detailed description set forth herein.

SWAN Level 3: In accordance with a SWAN Level 3 capability (wherein audio is presented to a user as he/she navigates a web site) that is provided by embodiments of the present invention, audio is synchronized at an object level on a web page(for example, a mouse over or a mouse click event). This means that predetermined audio segments are associated with objects within the web page. Thus, in accordance with the SWAN Level 3 capability, as the user navigates at the object level, audio segments associated with the objects are played. In accordance with one embodiment of the SWAN Level 3 capability, the user's appliance provides signals that inform the embodiment (through, for example, a web server add-in component) of the user's location in the web page in accordance with any one of a number of methods that are well known to those of ordinary skill in the art. The user's location, in turn, provides an indication of the audio segment associated therewith. Such a signal can be generated as a result of events such as, for example, a click of a mouse at the object location or a “mouse-over” event at the object location, which events are well known to those of ordinary skill in the art. In accordance with this embodiment, the signal can include an identification of the associated audio segment (which identification is stored for example, as a portion of the web page) or the location indication provided by the signal can be analyzed by, for example, a web server add-in component, to identify the associated audio segment. In accordance with this aspect of the present invention, the SWAN Level 3 capability operates with static web page content. It should be clear to those of ordinary skill in the art how to implement the SWAN Level 3 capability in light of the detailed description set forth herein.

SWAN Level 4: In accordance with the SWAN Level 4 capability (wherein audio is presented to a user as he/she navigates a web site) that is provided by embodiments of the present invention, audio is synchronized with dynamic data. For example, in accordance with the SWAN Level 4 capability, audio is associated with results, for example, of database queries. Thus, if a web page asked the user to enter information into a web form, audio is be associated with validation of items of information entered by the user on the form. In accordance with this embodiment, a web server add-in component would perform a validation of each item by, for example, querying a database in accordance with any one of a nutnber of methods that are well known to those of ordinary skill in the art. If the data were valid, the web server add-in component would send a request to an audio server to provide a predetermined audio segment. Similarly, if the data were not valid, the web server add-in component would send a request to the audio server to provide an alternative predetermined audio segment. It should be clear to those of ordinary skill in the art how to implement the SWAN Level 4 capability in light of the detailed description set forth herein.

SWAN Level 5: In accordance with a SWAN Level 5 capability (wherein audio is presented to a user as he/she navigates a web site) that is provided by embodiments of the present invention, audio is synchronized with timed visual animation. For, example, in accordance with the SWAN Level 5 capability, audio is associated with animations as they are displayed, for example, by the user's browser to provide a complete and integrated multimedia experience for the user. Thus, in accordance with a SWAN Level 5 embodiment, visual and audio effects are coordinated with the user's navigation of a web site. It should be clear to those of ordinary skill in the art how to implement the SWAN Level 5 capability in light of the detailed description set forth herein.

SWAN Level 6: In accordance with a SWAN Level 6 capability (wherein audio is presented to a user as he/she navigates a web site) that is provided by embodiments of the present invention, text, visuals, and/or audio can be stored in a database (the database can be located at a web server, a control server, or an audio server, or it can be remotely located therefrom and be accessible by any or all of a web server add-in component, a control server, and an audio server). In accordance with one embodiment of the SWAN Level 6 capability, content could be dynamically created at any time, and based on any number of factors. For example, if a web page provides a query format (for example, in accordance with the embodiment of the SWAN Level 4 capability described above), a dynamic configuration of multimedia content can be created and delivered to the user in response to a query. The database to be queried can be located on the same machines or on the same LAN as are the web/control/audio servers. In a further embodiment, databases to be queried could be just about anywhere, and have any number of structures. In a still further embodiment, the web page itself can contain a “map” for obtaining multimedia content from databases, which map provides, for example, query requests that are transmitted to, for example, a web server add-in component. It should be clear to those of ordinary skill in the art how to implement the SWAN Level 6 capability in light of the detailed description set forth herein.

SWAN Level 7: In accordance with a SWAN Level 7 capability (wherein audio is presented to a user as he/she navigates a web site) that is provided by embodiments of the present invention, coordinated live audio/visual presentations are provided (this is to be contrasted with coordinated prerecorded audio/visual presentations described above). In accordance with the SWAN Level 7 capability, a multimedia presentation comprises pre-recorded visuals augmented with pre-recorded audio content, for example, using the SWAN Level 5 capability described above. However, in accordance with the SWAN Level 7 capability, whenever the user visits certain sections of the web site, he/she will hear live audio, and have visuals being displayed changed as a result of actions taken by a person or persons leading a presentation. The difference between a presentation made using the SWAN Level 7 capability and a presentation made using a prior art system such as, for example, Placeware, is that a user utilizing the SWAN Level 7 capability has already started an audio session for other sections of the web site (which use, for example, the SWAN Level 5 capability). In the case of a prior art system such as, for example, Placeware, audio (normally set by means of a conference call external from the web site) is only used for the live presentation. Further, in accordance with the SWAN Level 7 capability, the visual presentations can either be synchronized at the object level on a web page with live audio or not, within the meaning of the levels of SWAN described above. For example, in a level of SWAN wherein the visual presentations are not synchronized with live audio (for example, SWAN Levels 1 and 2), whenever the user accesses a page at a web site, the user is presented a live audio presentation that is relevant to material displayed on the page as a whole (perhaps with references to specific sections of the visual presentation). In accordance with the SWAN Level 7 capability, by invoking appropriate commands displayed on a web page, the user can rewind the live multimedia presentation for review. To do this, the live audio is recorded, for example, by the audio server, so that the user can continue watching and listening, in a time delayed fashion, for example, a few seconds behind the live function. Then, by invoking the appropriate commands, the user can, at any time jump back to live content. Further, in accordance with the SWAN Level 7 capability, a presenter can control the visual pacing. If the visual content is set to animate at a specific time reference and a lengthy question occurs, the presenter could stop or slow the animations in the web browser to account for the delay. The converse is also true. Advantageously then, if audience members indicate that they have already heard enough on a topic, the presenter could skip ahead in the audio and in the visuals the audience would indicate their preference to move on by either saying this over the conference call, or selecting some option on the computer screen, or by pressing a predetermined button on their telephone keypad. Still further, in accordance with the SWAN Level 7 capability, by recording the live audio, the entire live presentation can be available for replays, for example, at a later time. Yet still further, when the user is receiving the live multimedia presentation, he/she could ask questions over the telephone connection, or type them into an optional text area in the browser window. The user's audio input may be captured by the audio server and transmitted to the presenter or converted to text using any one of a number of voice recognition methods that are well known to those of ordinary skill in the art for transmission to the presenter. In addition, the text provided by user input may be captured by the web server add-in component and transmitted to the presenter. In accordance with this embodiment, the user can go back/go forward to previous/next section or at a predetermined interval. It should be clear to those of ordinary skill in the art how to implement the SWAN Level 7 capability in light of the detailed description set forth herein.

Communication among Components of Embodiment 1000

In accordance with a preferred embodiment of the present invention, web server add-in components 150₁-150ₙ, control server 300, and audio servers 200₁-200ₘ communicate to/from each other using a highly compressed and efficient protocol (which protocol is described in detail below) which uses TCP/IP as a transport protocol. However, other transport protocols can be used as well, for example, Netbios, IPX/SPX, LU6.2, and so forth. When using TCP/IP as the transport protocol, communication can be configured to use UDP or TCP transports. However, UDP is preferred since the inter-component messages are very short, i.e., they are limited to a single network packet. Also, in a preferred embodiment, when embodiments of the present invention are configured using a local, private, high speed network, UDP is the optimal method.

Each component is informed (at configuration) of the IP addresses (primary and secondary(optional)) of the components with which they will communicate. Each incoming request/command is optionally (configurable) verified against this address list for the component in question to verify that the request/command is valid and has not originated from an unauthorized source. Each component is assigned a unique numeric ID (for example, web server add-in component ID; control server ID; and audio server ID) in its startup configuration file to uniquely identify it from other components in the embodiment. In a preferred embodiment, all web server add-in component IDs are unique in embodiment 1000; all audio server IDs are unique in embodiment 1000; and all control server IDs are unique in embodiment 1000. Normally there is only one control server in an embodiment. However audio servers can be shared among control servers and, in such embodiments, all control server IDs are unique so as not to confuse the audio servers.

All requests among components have the following standard header information (Note, in this embodiment, all ints (integers) are four bytes in length and are in network standard format (i.e., most significant byte first), all chars (characters) are one byte in length, and // signifies a comment):

| | |
|---|---|
| unsigned int size; | // The size (in bytes) of the request |
| unsigned int requestID; | // The id of the request (identifies |
| | each request) |
| unsigned int version; | // the version of the request |
| unsigned int requesterID; | // the id of the requester (either the |
| | // control server id, the audio server id, or |
| | // the web server add-in component id) |
| unsigned char requester- | // T or F, whether the |
| AcceptingNewConnections; | |
| | // requester is accepting new connections |
| unsigned int reserved0; | // Reserved or message specific information |
| unsigned int reserved1; | // Reserved or message specific information |
| unsigned int reserved2; | // Reserved or message specific information |
| unsigned int reserved3; | // Reserved or message specific information |

Individual requests contain request specific information following this

standard header, which specific information is described in detail below.

All replies to requests have the following format:

| | |
|---|---|
| unsigned int size; | // The size(in bytes) of this message |
| unsigned int replyID; | // The id of this message (always 100) |
| unsigned int version; | // The version of this message |
| unsigned int replyerID; | // The id of the sender of the reply (either the |
| | // control server id, the audio server id or |
| | // the web-server add-in component ID) |
| unsigned char replyer- | // T or F, whether the |
| AcceptingNewConnections; | |
| | // replyer is accepting new connections |
| unsigned int reserved0; | // (echoed from request) |
| unsigned int reserved1; | // (echoed from request) |
| unsigned int reserved2; | // (echoed from request) |
| unsigned int reserved3; | // (echoed from request) |
| unsigned int requestID; | // the id of the request that elicited this reply |
| unsigned char action; | // T or F, whether the request was carried out |
| unsigned int data0; | // reply specific numeric data |
| unsigned int data1; | // reply specific numeric data |
| unsigned int data2; | // reply specific numeric data |
| unsigned int data3; | // reply specific numeric data |
| unsigned int data4; | // reply specific numeric data |
| unsigned int data5; | // reply specific numeric data |
| unsigned int data6; | // reply specific numeric data |
| unsigned int data7; | // reply specific numeric data |
| unsigned char text[256]; | // reply specific character data |

In accordance with the preferred embodiment of the present invention, web server add-in components 150₁-150ₙ, control server 300, and audio servers 200₁-200ₘ all listen on predefined (via configuration parameters) TCP/IP ports (UDP and TCP) for messages (commands and requests) destined for them. Each component has one or more threads listening for each type of port (UDP or TCP) on individual or all network interfaces (configuration choice for component) configured for the machine on which they are running. Each component has many threads that actually process the requests/commands. The listening thread(s) pass the request to a processing thread in an operating system specific fashion. Some requests and commands require that the listening thread contact the other components before the processing thread can continue (command or request chaining). The number of processing threads is dynamic and can grow or shrink based on loading factors. The initial (minimum) and maximum number of request processing threads is set by information in configuration files read at component startup. Additionally, these values may be updated (and the appropriate number of threads started or stopped) while the component is running.

In accordance with a preferred embodiment of the present invention, web server add-in components 150₁-150ₙ, audio servers 200₁-200ₘ, and control server 300 periodically attempt to contact appropriate other components if no communication has occurred during a configurable “heart beat interval.” Each component creates a thread at component startup which is responsible for monitoring each adjacent component. This monitoring thread wakes up at the end of a heart beat interval. If no communication has taken place since the last heart beat interval (all adjacent components are tracked with the last time a communication was received from them), the monitoring thread sends a request for status information. If no response is received, the adjacent component is marked off-line and the appropriate action is taken. For example, if an audio server cannot contact a control server, any calls associated with that control server are disconnected after a notification message is played. Likewise, if a control server cannot contact a audio server, the user connection is removed from the connections list and all web server add-in components are instructed to remove the user/visitor ID from their connections list. If a control server cannot contact a web server add-in component and that is the only web server in embodiment 1000, the control server disconnects all current connections. If the “lost” component subsequently reconnects, it is notified that it was assumed down and to disconnect or request the reload of connected users, as appropriate. If all components are implemented as a single software application on a single machine, this intercomponent health-checking is not required.

In accordance with one embodiment of the present invention, configuration and/or status information for control server 300, audio servers 200₁-200ₙ, and embodiment 1000 are provided to web servers 100₁-100ₙ for display and/or use in update operations. For example, in this embodiment: (a) the status of embodiment 1000 is accessed by accessing the /isound/federation/status URL; (b) configuration of embodiment 1000 is accessed by accessing the /isound/federation/configuration URL; (c) status of control server 300 is accessed by accessing the /isound/ControlServer/Status URL; (d) configuration of control server 300 is accessed by accessing the /isound/ControlServer/configuration URL; (e) status of a specific one of audio servers 200₁-200ₙ is accessed by accessing the /isound/AudioServerXXXX/status URL (where XXX is the audio server ID); and (f) configuration information of a specific one of audio servers 200₁-200ₙ is accessed by accessing the /isound/AudioServerXXXX/configuration URL (where XXX is the audio server ID).

In accordance with one embodiment of the present invention, the configuration of each component of embodiment 1000 is updated by submitting an HTML form with the appropriate parameters to configuration URLs (/configuration) with a suffix of /update appended to the normal requesting URL (/configuration/update). Note, in accordance with this embodiment, updates are only allowed if the appropriate ones of control servers 300₁-300ₚ and/or audio servers 200₁-200ₘ are configured to accept remote updates from specific web server addresses, and only if the correct authorization credentials are presented with the request.

Web Server Add-in Components

As should be clear to those of ordinary skill in the art, the design and application programming interface (API) of this component of the inventive embodiment will change based on the type of web server and operating system used. As those of ordinary skill in the art readily understand, this is so because different types of web servers take a different approach to answering web browser requests. For example, Netscape web servers allow optional add-ins to be called for each request or only for specific requests (based on location or type) whereas, with Microsoft's IIS Web Server, optional code is called for each request regardless of the location or type of the requested file (this can be mitigated by requesting that the optional code only be called during specific request handling phases). Finally, optional Apache modules can be configured to be called for all requests or just requests for a specific server, document directory, or document type. Unfortunately Apache, must be recompiled and relinked for each optional module which is installed. Thus, on Netscape Enterprise and FastTrack servers, embodiments are implemented as Netscape Application Programming Interface (NSAPI) add-ins; on Microsoft's Internet Information Server (IIS), they are implemented as Internet Server Application Programming Interface (ISAPI) add-ins; and on Apache from the Apache group, they are implemented as Apache modules following the specifications of the Apache module API (C-API). In all cases, however, it is preferred (but not required) to implement this component of the inventive embodiment using the C++ programming language. For example, on Microsoft platforms, Microsoft's Visual C++ is the preferred compilation language and environment and on Unix or Linux platforms, GNU C/C++ is the preferred compilation language and environment.

In accordance with a preferred embodiment of the present invention, web server add-in components 150₁-150ₙ only send messages/requests to a control server.

// Request 1000. Request control server status
const unsigned int WS_CS_PROVIDE_STATUS = 1000;
// uses only STANDARD_REQUEST header.
// Request 1001. Request control server configuration information
const unsigned int WS_CS_PROVIDE_CONFIGURATION = 1001;
// uses only STANDARD_REQUEST header.
// Request 1002. Request a new user/visitor id from the control server
const unsigned int WS_CS_PROVIDE_VISITOR_ID = 1002;
// uses only STANDARD_REQUEST header.
// Request 1003. Request control server record information from a visitor.
const unsigned int WS_CS_SET_VISITOR_INFORMATION = 1003;
// STANDARD_REQUEST header followed by:

unsigned int visitorID;
char lastName[NAME_BUFFER_SIZE];
char firstName[NAME_BUFFER_SIZE];
char middleName[NAME_BUFFER_SIZE];
char title[NAME_BUFFER_SIZE];
char suffix[10];
char address1[ADDRESS_BUFFER_SIZE];
char address2[ADDRESS_BUFFER_SIZE];
char address3[ADDRESS_BUFFER_SIZE];
char address4[ADDRESS_BUFFER_SIZE];
char city[ADDRESS_BUFFER_SIZE];
char stateProvince[ADDRESS_BUFFER_SIZE];
char postalCode[20];
char primaryBusinessPhone[FORMATTED_PHONE_NUMBER_LENGTH];
char secondaryBusinessPhone[FORMATTED_PHONE_NUMBER_LENGTH];
char primaryHomePhone[FORMATTED_PHONE_NUMBER_LENGTH];
char secondaryHomePhone[FORMATTED_PHONE_NUMBER_LENGTH];
char primaryFaxPhone[FORMATTED_PHONE_NUMBER_LENGTH];
char secondaryFaxPhone[FORMATTED_PHONE_NUMBER_LENGTH];
char mobilePhone[FORMATTED_PHONE_NUMBER_LENGTH];
char primaryEmailAddress[CHAR_BUFFER_SIZE];
char secondaryEmailAddress[CHAR_BUFFER_SIZE];

// Request 1004(external) and 1005 (internal). Dial number. (dial-out mode)
const unsigned int WS_CS_DIAL_EXTERNAL_NUMBER = 1004;
const unsigned int WS_CS_DIAL_INTERNAL_NUMBER = 1005;
// STANDARD_REQUEST header followed by:

unsigned int visitorID; // user/visitor ID of the requester
unsigned int minutesWillingToWait; // zero if visitor is not willing to wait
unsigned char phoneNumberToDial
[FORMATTED_PHONE_NUMBER_LENGTH + 1];

// Request 1006. Disconnect a call.
const unsigned int WS_CS_DISCONNECT_CALL = 1006;
// STANDARD_REQUEST header followed by:

unsigned int visitorID; // user/visitor ID of the requester

// Request 1007(external) and 1008(internal). Reserve a line (dial-in mode)
const unsigned int WS_CS_RESERVE_EXTERNAL_LINE = 1007;
const unsigned int WS_CS_RESERVE_INTERNAL_LINE = 1008;
// STANDARD_REQUEST header followed by:

unsigned int visitorID; // user/visitor ID of the requester
// areaCodeForReservation is ONLY used for external reservations.
unsigned char areaCodeForReservation[AREA_CODE_LENGTH + 1];

// Request 1009. Play an audio file
const unsigned int WS_CS_PLAY_AUDIO_FILE = 1009;
// STANDARD_REQUEST header followed by:

| | |
|---|---|
| unsigned int visitorID; | // user/visitor ID of the requester |
| unsigned char interruptIfPlaying; | // T or F: Should a file that is currently |
| | // playing be interrupted or |
| | // should the file be played when the |
| | // current file is finished. |
| unsigned char setFileOnly; | // T or F: Should the file only be set |
| | // and not actually started? |

unsigned char fileNameToPlay[MAX_PATH + 1]; // no extension at end

// Request 1010. Process a command
const unsigned int WS_CS_PROCESS_COMMAND = 1010;
// STANDARD_REQUEST header followed by:

| | |
|---|---|
| unsigned int visitorID; | // user/visitor ID of the requester |
| unsigned int commandToProcess; | // Command code to be executed |

// Request 1011. Notify that the web server is shutting down.
const unsigned int WS_CS_NOTIFY_SHUTTING_DOWN = 1011;
// uses only STANDARD_REQUEST header.
// Request 1012. Provide the web server with embodiment statistics
const unsigned int WS_CS_PROVIDE_STATISTICS = 1012;
// uses only STANDARD_REQUEST header.
// Request 1013. Control server update your configuration (optional)
const unsigned int WS_CS_UPDATE_CONFIGURATION = 1013;
// STANDARD_REQUEST header followed by:
Control server configuration parameters
// Request 1014. Provide the control server updated configuration information
// (authorization required - optional)
const unsigned int WS_CS_UPDATE_WS_CONFIGURATION = 1014;
// STANDARD_REQUEST header followed by:
New web server add-in component configuration parameters
// Request 1015. Update an audio server configuration (authorization required)
// (optional)
const unsigned int WS_CS_UPDATE_AS_CONFIGURATION = 1015;
// STANDARD_REQUEST header followed by:
New audio server configuration parameters

In accordance with a preferred embodiment of the present invention, web server add-in components 150₁-150ₙ receive messages from control servers 300₁-300ₚ and from Java Applets or inventive functionality controlling JavaScript, VB Script, ActiveX controls or similar coding language running in the user's web browser.

The following messages are sent to web server add-in components 150₁-150ₙ from Java Applet/Controlling JavaScript, VBScript, ActiveX controls or similar coding languages: (a) play file immediate; (b) play file after current is complete; (c) set file immediate; and (d) set file after current is complete. These messages/requests are delivered by having the Java Applet or controlling JavaScript, attempt to access a file URL with an extension that is recognized by inventive embodiment 1000. In accordance with the preferred embodiment of the present invention, all of these messages are responded to with an “no response necessary” HTTP response code.

The following are further messages sent to web server add-in components 150₁-150ₙ from Java Applet/Controlling JavaScript: (a) pause; (b) play; (c) restart; (d) mute; (e) louder; (f) quieter; (h) advance 5; (i) advance 10; (j) advance 15; (k) advance n; (l) rewind5; (m) rewind10; (n) rewind15; (o) rewindn; (p) eject; (q) record; (r) disconnect; (s) summon (relevant for call center integration); (t) status—status from web server or control server; (u) statuscs—status from control server; and (v) statusas—status from audio server. These messages/requests are delivered by having the Java Applet/Controlling JavaScript, VBScript, ActiveX control or similar code attempt to access a file URL normally located in the /isound/commands directory of web servers 100₁-100ₙ. These files do not actually have to exist on web servers 100₁-100ₙ. In accordance with the preferred embodiment of the present invention, all of these messages are responded to with an “no response necessary” HTTP response code.

The various status commands determine the status of a connection. The status command is the only command that can be issued if an audio session has not yet established. Status can be determine at the web server add-in component level (using the status command); at the control server level (using the status and statuses commands); or at the audio server level (using the statusas command). The web server add-in component can be configured to record connection states as told to it by the control server. If the web-server add-in component is configured to record connection states, then the status command is fulfilled by the web server add-in component. If the web-server add-in component is not configured to record connection states, the status command is passed to the control server for processing (same as with the statuscs command). In one embodiment of the invention, the purpose of all the status commands is to set an HTTP cookie named status to indicate the state of the users connection. The possible values of this status cookie are: (a) off—no connection at this time; (b) ipt—in progress, telephone mode; (c) ipv—in progress, VoIP mode; (d) ont—connection established, telephone mode; (e) onv—connection established, VoIP mode; (f) ontm—same as d but currently muted; (g) onvm—same as e, but currently muted; (h) busy—in dial-out mode, the user specified number was busy; (i) noa—in dial-out mode, no answer; (j) asb—in dial out mode, all circuits were busy. “busy,” “noa,” and “asb” states are preserved for a predetermined amount of time (configurable and typically a short time) after the failure to allow for the reception on the status by the user. This is to allow the user to take the appropriate steps (if any) to change the conditions, and then re-initiate the connection. The status is retrieved by polling the web server add-in component or the control server during the condition initiation phase to relay the state to the user.

The following are Messages/Requests web server add-in components 150₁-150ₙ receive from control servers 300₁-300ₚ:

// Request 2000. Request web server status
const unsigned int CS_WS_PROVIDE_STATUS = 2000;
// uses only STANDARD_REQUEST header.
// Request 2001. Request web server set CS configuration information
const unsigned int CS_WS_SET_CS_CONFIGURATION = 2001;
// STANDARD_REQUEST header followed by:

| unsigned int startTime; | |
|---|---|
| unsigned int majorVersion; | |
| unsigned int minorVersion; | |
| unsigned int dialType; // in, out or both | |
| unsigned int mode; // phone, voip or both (bit vector) | |
| unsigned int connectionType; | // internal or external |
| unsigned int extensionLength; | // Length of the extensions that the |
| | // control server will dial if it is in |
| | // internal mode. |

unsigned char ipDomain[CHAR_BUFFER_SIZE]; // for cookies
unsigned char isCallBackEnabled; // T or F: control server mode
unsigned int vocodersAvailable; // VoIP mode (bit vector)

// Request 2002. Notify of status change
const unsigned int CS_WS_NOTIFY_STATUS_CHANGE = 2002;
// uses only STANDARD_REQUEST header.
// Request 2003. Notify control server shutting down
const unsigned int CS_WS_NOTIFY_SHUTTING_DOWN = 2003;
// uses only STANDARD_REQUEST header.
// Request 2004. Notify web servers that a user/visitor ID has a line
// reserved or a call in progress.
const unsigned int CS_WS_NOTIFY_IN_PROGRESS = 2004;
// uses STANDARD_REQUEST header followed by:

| | |
|---|---|
| unsigned int visitorID; | // user/visitor ID of the requester |

// Request 2005. Notify web servers that a user/visitor ID has a call connected.
const unsigned int CS_WS_NOTIFY_CONNECTED = 2005;
// uses STANDARD_REQUEST header followed by:

| | |
|---|---|
| unsigned int visitorID; | // user/visitor ID of the requester |

// Request 2006. Notify web servers that a user/visitor ID has a call disconnected.
const unsigned int CS_WS_NOTIFY_DISCONNECTED = 2006;
// uses STANDARD_REQUEST header followed by:

| | |
|---|---|
| unsigned int visitorID; | // user/visitor ID of the requester |

// Request 2007. Notify web servers of all the connections and those in progress.
const unsigned int CS_WS_SET_CS_CONNECTIONS = 2007;
// STANDARD_REQUEST header followed by:

unsigned int listLength;
unsigned int list[MAX_VISITOR_IDS_PER_MESSAGE]; // list of user/visitor ID

// Request 2008. Notify web servers of a large disconnection.
// An audio server shutdown, or a board/trunk failure.
const unsigned int CS_WS_SET_CS_DISCONNECTIONS = 2008;
// STANDARD_REQUEST header followed by:

unsigned int listLength;
unsigned int list[MAX_VISITOR_IDS_PER_MESSAGE]; // list of user/visitor IDs

// Request 2009. Notify web servers of federation configuration (optional)
const unsigned int CS_WS_SET_FEDERATION_CONFIGURATION = 2009;
// STANDARD_REQUEST header followed by:
Embodiment configuration information
// Request 2010. Notify web servers of embodiment statistics (optional)
const unsigned int CS_WS_SET_FEDERATION_STATISTICS = 2010;
// STANDARD_REQUEST header followed by:
Embodiment statistics information

The following is a sample configuration of an embodiment of an inventive web server add-in component using Netscape's FastTrack Web Server on Microsoft's Windows NT operating system. This sample file below is normally named obj.conf and is located in a web server specific configuration directory. In this example, the web server add-in component (addins.dll) is located in the C:\Program Files\isound\nsapi\bin directory. Invention specific configuration command lines are underlined.

The sample below uses the technique of using file extensions (MIME types—is, ispn, ispl, issn, issl) to detect HTTP requests to play or set audio files; and uses HTTP requests to the “/isound/commands” virtual directory to initiate audio commands (louder, etc.). As stated earlier this is but one way to accomplish the task of determining which HTTP requests are intended for the web server add-ins 150₁-150ₙ. If other approaches are used (e.g. conditional get requests) the statements in this configuration file would change accordingly.

Init fn=flex-init access=“C:/Program Files/Netscape/Server/httpd-adams1/logs/access”

format.access=“%Ses->client.ip%-%Req->vars.auth-user% [%SYSDATE%]\”%Req->reqpb.clf-request%\“%Req->srvhdrs.clf-status% %Req->srvhdrs.content-length% %Req->headers.if-modified-since%”

Init fn=load-types mime-types=mime.types

Init funcs=“is-init, is-set-connect-document, is-send-document, is-process-connect-info, is-set-disconnect-document, is-process-disconnect-info, is-play-audio, is-process-command” fn=load-modules shlib=“C:/Program Files/isound/nsapi/bin/addins.dll”

Init fn=is-init control server=12,udp,adams1,adams1b request port=90 threads=4 web server id=1 close connection=false, command time out=2, domain=.intensifi.org

<Object name=default>

NameTrans fn=assign-name from=/isound/commands/* name=is-process-command

NameTrans fn=assign-name from=/isound/connect/* name=is-connect

NameTrans fn=assign-name from=/isound/disconnect/* name=is-disconnect

NameTrans fn=pfx2dir from=/ns-icons dir=“C:/Program Files/Netscape/Server/ns-icons”

NameTrans fn=pfx2dir from=/mc-icons dir=“C:/Program Files/Netscape/Server/ns-icons”

NameTrans fn=document-root root=“C:/Program Files/Netscape/Server/docs”

PathCheck fn=nt-uri-clean

PathCheck fn=find-pathinfo

PathCheck fn=find-index index-names=“index.html,home.html,index.htm,home.htm”

ObjectType fn=type-by-extension

ObjectType fn=force-type type=text/plain

Service method=(GET|HEAD) type=isound-internal/audio fn=is-play-audio

Service method=(GET|HEAD) type=magnus-internal/imagemap fn=imagemap

Service method=(GET|HEAD) type=magnus-intemal/directory fn=index-common

Service method=(GET|HEAD) type=*˜magnus-intemal/* fn=send-file

AddLog fn=flex-log name=“access”

</Object>

<Object name=cgi>

ObjectType fn=force-type type=magnus-internal/cgi

Service fn=send-cgi

</Object>

<Object name=is-process-command>

Service method(GET|HEAD) fn=is-process-command

</Object>

<Object name=is-connect>

NameTrans fn=is-set-connect-document

Service method=(GET|HEAD) type=text/html fn=is-send-document

Service method=(GET|POST) type=isound-internal/form fn=is-process-connect-info

</Object>

<Object name=is-disconnect>

NameTrans fn=is-set-disconnect-document

Service method=(GET|HEAD) type=text/html fn=is-send-document

Service method=(GET|POST) type=isound-internal/form fn=is-process-disconnect-info

</Object>

The first underlined section “Init funcs= . . . ” indicates that the Netscape FastTrack Web Server is to load the IntenseSound dynamic link library (dll) from the specified directory. The Netscape server is also told to be aware of several functions in this dll which will be called by directives later in the file. The second underlined section “Init fn= . . . ” initializes embodiment 150 (calls is-init): (a) to set the web server id to 1; (b) to set the control server ID to contact to 12; (c) to use UDP as the normal protocol when contacting control server 300; (d) to use the IP interface known as “adams1” as a primary interface when contacting the control server; (e) to use the IP interface known as “adams1b” as a secondary interface when contacting control server 300; (f) to specify 90 as the UDP and TCP port on which to listen on for messages from control server 300 on all IP interfaces configured on the local machine; (g) to set the initial number of request processing threads (messages from control server 300 to 4); (h) indicates not to close the socket connection after each isound request; (i) set the timeout to two seconds—no commands within two seconds of a play or set request.; and (j) overrides the domain specified by the control server with “intensifi.org”. The domain is used to set HTTP cookies. The control server domain would be overriden where a single control server was being shared by multiple independent web servers. In other embodiments of the present invention, these and other parameters may be set forth in a specific configuration file separate from a web server configuration file to ease reconfiguring the inventive components. The third, fourth and fifth underlined sections “NameTrans fn= . . . ” name Netscape “configuration styles” to use when documents in specific directories are requested. The styles are defined below. The sixth underlined section “Service method= . . . ” indicates that any HTTP GET or HEAD requests for files of type isound-internal/audio (decided by mime type described below) are to be processed by the function is-play-audio. This function sends the play file request to control server 300, waits for a response, sends a “no response necessary” response code to the user's web browser, and then sets status flags to tell Netscape not to process the request further. The rest of the underlined sections tell what actions to take based on URL requests that met the style types defined earlier. Commands are processed by is-process-command. Connect and disconnect requests are processed by the appropriate styles as well. Note that the connect and disconnect styles have two responsibilities: (a) to determine which connect or disconnect document to send to the user based on current configurations and connection status and (b) to process the form that is eventually submitted by the user to process the connect or disconnect request itself. In all cases, the processing sends a “no response necessary” HTTP response code back to the requesting web browser, and tells the Netscape web server that no further processing is necessary.

The following is a sample section of configuration information for the inventive web server add-in components using Netscape's FastTrack Web Server on Microsoft's Windows NT operating system. This sample section below is normally located in the mime.types file and is located in the web server specific configuration directory.

type=isound-internal/audio exts=is

type=isound-internal/audio exts=ispn

type=isound-internal/audio exts=ispl

type=isound-internal/audio exts=issn

type=isound-internal/audio exts=issl

type=isound-internal/parsed-html exts=is_html

type=isound-internal/form exts=is_form

The first five lines specify that if any requests come in for files with the named extensions, the request's internal type is to be set to “isound-internal/audio”. When this occurs, the appropriate inventive function processes these requests. The last two entries state that if requests come in for files with the named extensions that the request's internal type is to be set to “isound-internal/parsed-html” or “isound-internal/form”. When this occurs, the appropriate inventive function processes these requests.

Control Server

Control server 300 (a daemon background process on Unix, a service background process on Windows NT) receives messages/commands/requests from web server add-in components 150₁-150ₙ and audio-servers 200₁-200ₙ, processes them, maintains a state for connections, and sends appropriate message/command/request to other components of the inventive embodiment.

In accordance with a preferred embodiment of the present invention, incoming messages/commands/requests are optionally logged for later review. User sessions can also be optionally logged for later review and/or billing. In a preferred embodiment, control server 300 is capable of running in debug mode where it will display on a console window detailed information pertaining to the messages/commands/requests that it receives. Further, control server 300 can be configured to not allow any more new connections or to allow new connections (the default). In accordance with the present invention, this is useful when control server 300 is to be taken offline for maintenance, but current connections are to remain unaffected. Once all connections have ceased, control server 300 can then be taken offline safely. However, audio functions of embodiment 1000 will be unavailable until control server 300 comes back online and notifies its associated audio servers and web server add-in components that it is available for processing.

In addition, and in accordance with the present invention, control server 300 keeps a list keyed by user/visitor ID which tracks whether the user is connected or in the process of connecting. This list is updated based on messages being sent to control server 300 from audio servers 200₁-200ₘ. Control server 300 can optionally also maintain a list of users waiting to connect when no lines were available to satisfy their original connection request. Control server 300 also maintains the next available user/visitor ID. This value is obtained from a configuration file at startup. Upon shutdown, the next available number is written back to a predetermined file for a subsequent startup. During operations, control server 300 controls access to the next available user/visitor ID with read/write wave locks (described above). In one embodiment of the present invention, 100 (configurable) user/visitor IDs are cached at a time. The next available user/visitor ID (after the cached 100) is written back to the configuration file to prevent more then 100 user/visitor IDs from being lost if control server 300 were to crash for some reason. Once these 100 user/visitor IDs are used, another 100 are obtained by reading a user/visitor ID file and updating its contents for the next potential read. The number of visitor ID's to cache is not fixed at 100. It is configurable, but defaults to 100.

In all operating systems, it is preferred (but not required) to implement this component of the inventive embodiment using the C++ programming language. For example, on Microsoft platforms, Microsoft's Visual C++ is the preferred compilation language and environment, and on Unix or Linux platforms, GNU C/C++ is the preferred compilation language and environment.

Messages control server 300 can send are described: (a) below in the discussion regarding messages that can be received by audio servers 200₁-200ₘ and (b) above in the discussion regarding messages that can be received by web server add-in components 150₁-150ₙ.

Messages control server 300 can receive are described: (a) below in the discussion regarding messages that can be sent by audio servers 200₁-200ₘ and (b) above in the discussion regarding messages that can be sent by web server add-in components 150₁-150ₙ.

Configuration of control server 300 is controlled by several configuration files located in the same or parallel directory as the executable files of control servers 100₁-100ₙ. The first configuration file, configuration.cs, is the main file used to control the operation of control server 300. It contains multiple parameters. The parameters and their uses are described below.

| Parameter | sample value | Usage |
|---|---|---|
| control server: | 19,adams1 | Identifies the control server host and its ID |
| listening port number: | 83 | TCP and UDP port to listen on |
| logging directory: | | directory where to log information |
| log configuration: | true | log configuration on startup |
| log warnings: | true | log warnings |
| log informational messages: | true | log informational messages |
| log usage: | true | log audio server usage |
| log requests: | false | log incoming requests |
| log visitors: | false | log the visitors |
| accepting new connections: | true | allow new connections on startup |
| admin consoles: | false | can configuration be updated externally |
| admin password: | sadasf | password required for admin functions |
| min udp request threads: | 1 | min UDP request processing threads |
| max udp request threads: | 12 | max UDP request processing threads |
| delta udp request threads: | 2 | delta number of UDP threads to start/stop |
| min tcp request threads: | 4 | min number of TCP request processing threads |
| max tcp request threads: | 20 | max number of TCP request processing threads |
| delta tcp request threads: | 2 | delta number of TCP threads to start/stop |
| max concurrent udp datagrams: | 100 | maximum number of concurrent UDP requests |
| max concurrent tcp connections: | 100 | maximum number of concurrent TCP requests |
| number of sending threads: | 20 | Number of threads used to send messages to audio |
| | | servers and web servers |
| extension length: | 5 | how long are extensions |
| mode: | both | phone, voip or both |
| | | Note: This setting simply allows certain types of audio |
| | | servers to join the federation. The actual mode can |
| | | change over time as audio servers come online or go |
| | | offline. Web server add-ins are notified as the mode |
| | | changes. Additionally the control server maintains an |
| | | internal state as to which vocoders are available. The |
| | | state is determined as audio servers announce |
| | | themselves and their configuration to the control server. |
| dial type: | out | configured for dial-in or dial-out, or both |
| | | Note: This setting detemines which type of audio |
| | | server will be used to initiate connections to users. |
| | | An audio server in an incompatible mode can still be |
| | | part of the federation, however it will be used |
| | | exclusively for private ports as the control server |
| | | will ignore it |
| allow private lines: | yes | allow private lines to be configured |
| | | (if not, private lines are ignored) |
| connection type: | external | connected to PSTN (external) or PBX (internal) |
| line reservation time: | 4 | number of minutes to reserve a line before |
| | | freeing the line for another's use. |
| max active calls: | 1000 | number of active calls to support (work in |
| | | conjunction with the authorization key) |
| authorization key: | 12QW-ER45-SD89 | controls which host and at what capability |
| | | level the control server is running, enterprise, |
| | | workgroup or developer, (described below) |
| max call inactive time: | 10 | how long before auto disconnect |
| heart beat interval: | 120 | how long to wait between each attempt |
| | | to contact the associated audio servers and |
| | | web server add-in components |
| ip domain: | .adams.com | domain to use for setting HTTP cookies |
| command timeout window: | 2 | number of seconds after requests before commands |
| | | are processed |
| enable callback: | false | If no ports are available should call back when |
| | | available be used? |
| Max callback time: | 20 | If in callback mode how long before callsback are too |
| | | old? |
| Max waiting visitors: | 10 | If in callback mode how many waiters to allow? |

The second configuration file, web_servers.cs, lists the web server add-in components that are part of embodiment 1000 managed by control server 300. For example: web server:1,80,udp,90,adams1, 10.0.10.12

This example states that: (a) web server add-in component ID 1 listens to HTTP requests on port 80 (the default); (b) UDP is the preferred protocol to use when making or responding to requests; (c) 90 is the UDP and TCP port that the web server add-in component will be listening on; (d) the name of the primary IP interface to use when contacting this web server add-in component is adams1; and (e) the secondary IP interface to use when contacting this web server add-in component is 10.0.10.12.

The third configuration file, audio_servers.cs, lists the audio servers that are part of embodiment 1000 managed by control server 300. For example:

audio server: 19,udp,83,adams1

This example states that: (a) audio server ID is 19; (b) UDP is the preferred protocol to use when making or responding to requests; (c) 83 is the UDP and TCP port that the audio server will be listening on; (d) the name of the primary IP interface to use when contacting this audio server is adams1; and (e) no secondary IP interface has been specified.

The fourth configuration file, next_visitor_id.cs, stores the next available user/visitor ID as an editable number. While running, the value stored in this file is the next user/visitor ID to use after the internally cached values are exhausted. When control server 300 shuts down, the next available user/visitor ID is written back to this file so as not to needlessly waste user/visitor IDs.

The fifth configuration file, allowed_numbers.cs (optional file and optional contents), stores a list of allowed area codes, area code and prefixes, complete numbers and domains. If any of this information is specified then all requests to the control server must be listed in this information or the call will be disallowed. It is highly unlikely that the “number”directive will ever be used as it drastically limits the numbers that can be dialed. It is more likely that the area code directive will be the only one used. This information is only consulted if control server 300 is configured in dial-out mode. For example:

area code:303 # denver,

area code:714 # orange county,

area code & prefix:650654

number:6506549999

domain: intensifi.com # VoIP only

The sixth configuration file, disallowed_numbers.cs, stores a list of disallowed area codes, prefixes, area code and prefixes, complete numbers and domains. If any of this information is specified then all requests to the control server will be checked against this information before the call is allowed. This information is only consulted if control server 300 is configured in dial-out mode. For example:

area code:800 # No toll free numbers as caller id cannot be blocked.

| | |
|---|---|
| area code: 888 | # No toll free numbers as caller id cannot |
| | be blocked. |
| area code: 900 | # No toll numbers |
| prefix: 976 | # No toll numbers |
| prefix: 555 | # reserved |
| area code & prefix: 650506 | # competitor |
| area code & prefix: 650767 | # time |
| number: 6502937000 | |
| domain: badcompany.com | # VoIP only |

Audio Server

Audio servers 200₁-200ₘ (a daemon background process on Unix, a service background process on Windows NT) receive messages/commands/requests from control servers 300₁-300ₚ and users connected over telephone lines or VoIP connections, process them, maintain a state for connections, and send the appropriate message/request to control servers 300₁-300ₚ when appropriate.

In accordance with a preferred embodiment of the present invention, incoming messages/commands/requests are optionally logged for later review. User connections can also be optionally logged for later review and/or billing. Audio servers 200₁-200ₘ are capable of running in debug mode where detailed information pertaining to the messages/commands/requests that are received will be displayed on a console window. Audio servers 200₁-200ₘ can be configured to not allow any more new connections or to allow new connections (the default). This is useful when an audio server is to be taken offline for maintenance but current connections are to remain unaffected. Once all connections have ceased, the audio server can then be taken offline safely.

In a preferred embodiment, each of audio servers 200₁-200ₘ keeps a list keyed by a board number/port number combination which tracks port allocation (use by a particular control server and user/visitor), status, configuration and state. In accordance with a preferred embodiment of the present invention, this list is managed by a “state machine” which tracks the current state of the port in question and what the next possible state is based on allowed types of telephony events, or inventive functionality generated events that might occur. The “states” of the state machine that must be tracked are specific to the computer telephony board types (Natural Microsystems, Dialogic, etc.) installed in the particular audio server; which computer telephony boards and methods of use thereof are well known to those of ordinary skill in the art.

In all operating systems, it is preferred (but not required) to implement this component of the inventive embodiment using the C++ programming language. For example, on Microsoft platforms, Microsoft's Visual C++ is the preferred compilation language and environment, and on Unix or Linux platforms, GNU C/C++ is the preferred compilation language and environment.

The following are Messages/Requests audio servers 200₁-200ₘ send to control servers 300₁-300ₚ:

// Request 3000. Request control server status.
const unsigned int AS_CS_PROVIDE_STATUS = 3000;
// uses only STANDARD_REQUEST header.
// Request 3001. Update audio server base configuration information
const unsigned int AS_CS_SET_AS_BASE_CONFIGURATION = 3001;
// uses STANDARD_REQUEST header followed by:

unsigned int startTime; // time that the audio server started.
unsigned int majorVersion;
unsigned int minorVersion;
unsigned int mode; // phone or VoIP
unsigned int dialType; // in or out
unsigned int connectionType; // internal or external
unsigned int extensionLength; // how long are extensions
unsigned int lineReservationTime; // how long to reserve lines
unsigned int maxInactiveTime; // how long before auto disconnect
unsigned char isShared; // used my multiple control servers
unsigned char arePrivateConnectionsAllowed; // has private lines
unsigned char localAreaCode[AREA_CODE_LENGTH];
unsigned char usingAllowedNumbers; // allowed numbers in use
unsigned char usingDisallowedNumbers; // disallowed numbers in use
unsigned char voipIPInterface[IP_INTERFACE_LENGTH];
unsigned int voipVocoder; // G723.1, G729a, G711, GSM, etc. (bit vector)

// Request 3002. Update audio server allowed area code configuration information
const unsigned int AS_CS_SET_AS_ALLOWED_AREA_CODES = 3002;
// uses STANDARD_REQUEST header followed by:

unsigned int listLength;
unsigned char list[MAX_AREA_CODES][AREA_CODE_LENGTH];

// Request 3003. Update audio server allowed area codes and
// prefixes configuration information
const unsigned int AS_CS_SET_AS_ALLOWED_AREA_CODE_AND_PREFIXES = 3003;
// uses STANDARD_REQUEST header followed by:

unsigned int listLength;
unsigned char list[MAX_AREA_CODE_AND_PREFIXES]

[AREA_CODE_LENGTH + PREFIX_LENGTH];

// Request 3004. Update audio server allowed complete numbers

| | |
|---|---|
| // | configuration information |

const unsigned int AS_CS_SET_AS_ALLOWED_COMPLETE_NUMBERS = 3004;
// uses STANDARD_REQUEST header followed by:

unsigned int listLength;
unsigned char list[MAX_COMPLETE_NUMBERS]

[COMPLETE_PHONE_NUMBER_LENGTH];

// Request 3005. Update audio server allowed domains configuration information
const unsigned int AS_CS_SET_AS_ALLOWED_DOMAINS = 3005;
// uses STANDARD_REQUEST header followed by:

unsigned int listLength;
unsigned char list[MAX_DOMAINS]

[DOMAIN_LENGTH];

// Request 3006. Update audio server disallowed area code

| | |
|---|---|
| // | configuration information |

const unsigned int AS_CS_SET_AS_DISALLOWED_AREA_CODES = 3006;
// uses STANDARD_REQUEST header followed by:

unsigned int listLength;
unsigned char list[MAX_AREA_CODES][AREA_CODE_LENGTH];

// Request 3007. Update audio server disallowed area code

| | |
|---|---|
| // | and prefixes configuration information |

const unsigned int AS_CS_SET_AS_DISALLOWED_AREA_CODE_AND_PREFIXES =
3007;
// uses STANDARD_REQUEST header followed by:

unsigned int listLength;
unsigned char list[MAX_AREA_CODE_AND_PREFIXES]

[AREA_CODE_LENGTH + PREFIX_LENGTH];

// Request 3008. Update audio server disallowed prefixes

| | |
|---|---|
| // | configuration information |

const unsigned int AS_CS_SET_AS_DISALLOWED_PREFIXES = 3008;
// uses STANDARD_REQUEST header followed by:

unsigned int listLength;
unsigned char list[MAX_PREFIXES][PREFIX_LENGTH];

// Request 3009. Update audio server disallowed complete numbers

| | |
|---|---|
| // | configuration information |

const unsigned int AS_CS_SET_AS_DISALLOWED_COMPLETE_NUMBERS = 3009;
// uses STANDARD_REQUEST header followed by:

unsigned int listLength;
unsigned char list[MAX_COMPLETE_NUMBERS]

[COMPLETE_PHONE_NUMBER_LENGTH];

// Request 3010. Update audio server disallowed domains

| | |
|---|---|
| // | configuration information |

const unsigned nt AS_CS_SET_AS_DISALLOWED_DOMAINS = 3010;
// uses STANDARD_REQUEST header followed by:

unsigned int listLength;
unsigned char list[MAX_DOMAINS]

[DOMAIN_LENGTH];

// Request 3011. Status change
const unsigned int AS_CS_NOTIFY_STATUS_CHANGE = 3011;
// uses only STANDARD_REQUEST header
// Request 3012. Notify audio server shutting down
const unsigned int AS_CS_NOTIFY_SHUTTING_DOWN = 3012;
// uses only STANDARD_REQUEST header
// Request 3013. Update audio server port status
const unsigned int AS_CS_UPDATE_PORT_COUNTS = 3013;
// uses STANDARD_REQUEST header followed by:

int deltaNumberOfInternalPorts;
int deltaNumberOfInternalPortsInuse;
int deltaNumberOfExternalPorts;
int deltaNumberOfExternalPortsInUse;
int deltaNumberOfPrivatePorts;
int deltaNumberOfPrivatePortsInUse;

// Request 3014. Notify visitor is disconnected (or timed out)
const unsigned int AS_CS_NOTIFY_DISCONNECTED = 3014;
// uses STANDARD_REQUEST header followed by:

unsigned int visitorID;
unsigned char didVisitorInitiateDisconnection; // used to reinitiate

// in case of equipment failure

// Request 3015. Notify Visitor is connected
const unsigned int AS_CS_NOTIFY_CONNECTED = 3015;
// uses STANDARD_REQUEST header followed by:

unsigned int visitorID;
unsigned int boardNumber; // board connected to
unsigned int portNumber; // port connected to
unsigned char isPrivateConnection; // T or F occurred on private line?

// Request 3016. Notify web servers of a large disconnection.
// An audio server shutdown, or a board or trunk failure.
const unsigned int AS_CS_SET_AS_DISCONNECTIONS = 3016;
// uses STANDARD_REQUEST header followed by:

unsigned int listLength;
unsigned int list[MAX_VISITOR_IDS_PER_MESSAGE]; // visitors

// disconnected

// Request 3017. Update audio server proximity are codes.
// proximity area codes are used to determine which area codes are
// dialed by simply prefixing a 1 and which can potentially benefit from
// long distance access companies (10-10-321 for example)
const unsigned int AS_CS_SET_AS_PROXIMITY_AREA_CODES = 3017;
// uses STANDARD_REQUEST header followed by:

unsigned int listLength;
unsigned char list[MAX_AREA_CODES][AREA_CODE_LENGTH];

The following are Messages/Requests audio servers 200ₗ - 200ₘ receive from

control servers 300ₗ - 300ₚ:
// Request 1000. Request audio server status
const unsigned int CS_AS_PROVIDE_STATUS = 1000;
// uses only STANDARD_REQUEST header.
// Request 1001. Request audio server configuration information
const unsigned int CS_AS_PROVIDE_CONFIGURATION = 1001;
// uses only STANDARD_REQUEST header.
// Request 1002. Notify of status change
const unsigned int CS_AS_NOTIFY_STATUS_CHANGE = 1002;
// uses only STANDARD_REQUEST header.
// Request 1003. Notify control server shutting down
const unsigned int CS_AS_NOTIFY_SHUTTING_DOWN = 1003;
// uses only STANDARD_REQUEST header.
// Request 1004(external) and 1005 (internal). dial a call
const unsigned int CS_AS_DIAL_EXTERNAL_NUMBER = 1004;
const unsigned int CS_AS_DIAL_INTERNAL_NUMBER = 1005;
// uses STANDARD_REQUEST header followed by:

| unsigned int webServerID; // webServerID of the original connection point | |
|---|---|
| unsigned int visitorID; | // user/visitor ID of the requester |
| unsigned int lineReservationTime; | // how long to reserve the line |
| unsigned int accessCode; | // entry to allow user to confirm call |

unsigned char phoneNumberToDial

[FORMATTED_PHONE_NUMBER_LENGTH + 1];

// Request 1006 and 1007. Reserve a line
const unsigned int CS_AS_RESERVE_EXTERNAL_LINE = 1006;
const unsigned int CS_AS_RESERVE_INTERNAL_LINE = 1007;
// uses STANDARD_REQUEST header followed by:

| unsigned int webServerID; | // webServerID of the original connection point |
|---|---|
| unsigned int visitorID; | // user/visitor ID of the requester |
| unsigned int lineReservationTime; // how long to reserve the line | |
| unsigned int accessCode; | // entry to allow user to confirm call |

// Request 1008. Disconnect a call.
const unsigned int CS_AS_DISCONNECT_CALL = 1008;
// uses STANDARD_REQUEST header followed by:

| | |
|---|---|
| unsigned int visitorID; | // user/visitor ID of the requester |
| unsigned int boardNumber; | // used to specify board key |
| unsigned int portNumber; | // used to specify port key |

// Request 1009. process a command.
const unsigned int CS_AS_PROCESS_COMMAND = 1009;
// uses STANDARD_REQUEST header followed by:

| | |
|---|---|
| unsigned int visitorID; | // user/visitor ID of the requester |
| unsigned int boardNumber; | // where connected |
| unsigned int portNumber; | // where connected |
| unsigned int commandToProcess; | // which command |

// Request 1010. Play an audio file
const unsigned int CS_AS_PLAY_AUDIO_FILE = 1010;
// uses STANDARD_REQUEST header followed by:

| | |
|---|---|
| unsigned int visitorID; | // user/visitor ID of the requester |
| unsigned int webServerID; | // web server where the request originated |
| unsigned int boardNumber; | // where connected |
| unsigned int portNumber; | // where connected |
| unsigned char interruptIfPlaying; | // T or F, Should a file that is currently |
| | // playing be interrupted or |
| | // should the file be played when the |
| | // current file is finished. |
| unsigned char setFileOnly; | // T or F Should the file only be set |
| | // and not actually started? |

unsigned char fileNameToPlay[MAX_PATH + 1];

// Request 1011. Notify audio server to disconnect all calls
// Control server shutting down or web server shutting down (if only one web server)
const unsigned int CS_AS_DISCONNECT_ALL_CALLS = 1011;
// uses only STANDARD_REQUEST header.
// Request 1012. Notify audio server to update configuration (optional)
const unsigned int CS_AS_SET_AS_CONFIGURATION = 1012
// uses STANDARD_REQUEST header followed by:
Audio server configuration information

Configuration of the audio servers is controlled by several configuration files located in the same or parallel directory as the executable files of audio servers 100₁-100ₙ. The first configuration file, configuration.as, is the main file used to control the operation of the audio servers. It contains multiple parameters. The parameters and their uses are described below.

| Parameter | sample value | Usage |
|---|---|---|
| audio server: | 19, adams 1 | Identifies the audio server and its ID |
| listening port number: | 83 | TCP and UDP port to listen on |
| mode: | voip | determines which mode the audio server |
| | or phone | is running in |
| logging directory: | | directory for logging information |
| log configuration: | true | log configuration on startup |
| log warnings: | false | whether or not to log warnings |
| log informational messages: | true | log informational messages |
| log requests: | false | Whether or not to log individual command |
| | | and play/set requests |
| log usage: | true | log audio server usage |
| accepting new connections: | true | allow new connections on startup |
| admin consoles: | false | can configuration be updated externally |
| admin password: | xyz | password required for admin functions |
| min udp request threads: | 1 | min UDP request processing threads |
| max udp request threads: | 12 | max UDP request processing threads |
| delta udp request threads: | 2 | delta number of UDP threads to start/stop |
| min tcp request threads: | 4 | min number of TCP request processing threads |
| max tcp request threads: | 20 | max number of TCP request processing threads |
| delta tcp request threads: | 2 | delta number of TCP threads to start/stop |
| min telephony event threads: | 2 | min telephony event processing threads |
| max telephony event threads: | 24 | max telephony event processing threads |
| delta telephony event threads: | 2 | delta number of telephony threads to start/stop |
| max concurrent udp datagrams: | 100 | max number of concurrent UDP requests |
| max concurrent tcp connections: | 100 | max number of concurrent TCP requests |
| ports per telephony event listening thread: | 2 | number of telephony ports to manage per |
| | | telephony event listening thread |
| event slots per telephony port: | 10 | Number of simultaneous pending events |
| | | for each telephony or VoIP port |
| number of sending threads: | 10 | number of threads used to send messages to |
| | | control servers |
| local area code: | 650 | local area code where audio server is installed |
| proximity area codes: | 408, 415, 510 | proximity area codes (no long distance service) |
| dial local area code: | false | force dial local area code if number is in same |
| | | area code |
| extension length: | 5 | in internal mode, how long are extensions |
| outside line sequence: | | sequence to obtain an outside line |
| | | (only used when in internal mode) |
| disable caller id sequence: | *82, | how to disable caller ID blocking on |
| | | outbound calls (not recommended) |
| disable call waiting sequence: | *70, | how to disable call waiting on outbound calls |
| long distance code: | 1 | code to dial for long distance numbers |
| dial type: | out | configured for dial-in or dial-out |
| allow private lines: | yes | allow private lines to be configured |
| | | (if not, private lines are ignored) |
| connection type: | external | connected to PSTN (external) or PBX (internal) |
| line reservation time: | | number of minutes to reserve a line before |
| | | freeing the line for another's use. |
| max active calls: | 1000 | number of active calls to support (work in |
| | | conjunction with the authorization key) |
| authorization key: | 12QW-ER45-SD89 | controls which host and at what capability |
| | | level the audio server is running (enterprise, |
| | | workgroup or developer, see below) |
| max call inactive time: | 10 | how long before auto disconnect |
| heart beat interval: | 120 | how long to wait between each attempt |
| | | to contact the associated control servers |
| generic audio file message directory: | xxx | Where the generic messages are stored |
| | | (i.e., you pressed . . . ) |
| audio message file format: | wave | The format of the audio files stored on the |
| | | audio server. Telephony vendor specific |
| vocoder type: | G711, | If in VoIP mode, the vocoder to use |
| | G723, | |
| | G729, | |
| | or GSM | |
| vocoder file: | filename.ext | if in VoIP mode the vocoder program file to |
| | | use (optional) |
| voip interface: | adams1c | If in VoIP mode the network interface to use |
| | | for VoIP traffic |
| rtp base port number: | 5000 | if in VoIP mode the first UDP port to use |
| | | for RTP/RTCP traffic |
| ivr ports per dsp: | 4 | If in VoIP mode the number of channels |
| | | (connections) each DSP can process |

The second configuration file, control_servers.as, lists the control servers that the audio server will support. For example:

control server: 12,udp,82,adams1

This example states that: (a) the control server ID is 12; (b) UDP is the preferred protocol to use when making or responding to requests; (c) 82 is the UDP and TCP port control server 300 will be listening on; (d) the name of the primary IP interface to use when contacting this control server is adams1; and (e) no secondary IP interface has been specified.

The third configuration file, allowed_numbers.as, stores a list of allowed area codes, area code and prefixes, complete numbers and domains. If any of this information is specified then all requests to the audio server must be listed in this file or the call will be disallowed. It is highly unlikely that the “number” directive will ever be used as it drastically limits the numbers that can be dialed. It is more likely that the area code directive will be the only one used. This information is only consulted if the audio server is configured in dial-out mode. This information is transferred to control server 300 on startup. Control server 300 performs all the list checking. For example:

area code:303 # denver,

area code:714 # orange county,

area code & prefix:650654

number:6506549999

domain: intensifi.org # VoIP only

The fourth configuration file, disallowed_numbers.as, stores the list of disallowed area codes, prefixes, area code and prefixes, complete numbers and domains. If any of this information is specified then all requests to the audio server will be checked against this information before the call is allowed. This information is only consulted if the audio server is configured in dial-out mode. This information is transferred to control server 300 on startup. Control server 300 performs all the list checking. For example:

| | |
|---|---|
| area code: 800 | # No toll free numbers as caller id cannot |
| | be blocked. |
| area code: 888 | # No toll free numbers as caller id cannot |
| | be blocked. |
| area code: 900 | # No toll numbers |
| prefix: 976 | # No toll numbers |
| prefix: 555 | # reserved |
| area code & prefix: 650506 | # competitor |
| area code & prefix: 650767 | # time |
| number: 6502937000 | |
| domain: badcompany.com | # VoIP only |

The fifth configuration file, directory_mapping.as, lists the directories to locate audio files for specific control server and web-server add-in component mappings. For example:

directory mapping: 12,1,C:\Program Files\isound\Audio Server\audio\CS 12\WS1

This example states: for control server ID #12 and web server add-in component ID #1, use C:\Program Files\isound\Audio Server\audio\CS12\WSI as the root directory when searching for audio files to play.

The sixth configuration file, telephony_boards.as, lists the telephony protocols (telephony board vendor specific, natural microsystems, Dialogic, etc.) to run on each installed telephony board. Examples:

board:0,1ps0 #standard analog lines

board:0,wnk0 #T1 or E1 trunks

board:0,nocc,voip #board used for VoIP processing

This first example states: for board 0, use the lps0 protocol for all ports on the board. This sample is for Natural Microsystems boards which use analog interfaces in the United States.

This second example states: for board 0, use the wink 0 protocol for all ports on the board. This sample is for Natural Microsystems boards which use digital interfaces in the United States.

This third example states: for board 0, use the nocc protocol for all ports on the board. This sample is for Natural Microsystems boards which uses voice over internet protocol (VoIP) in any country.

The seventh configuration file, port_phone_numbers.as, lists the phone numbers for each board port combination, and whether or not the port is for a private line. For example:

phone number: 1,0,650-654-9999,p # outside line connected

This example shows that board 1, port 0 has a telephone number of 650-654-9999 and that it is private. Private ports will never be reserved or dialed out on by control server 300. If the port was not private (no ,p suffix) and the audio server and control server 300 were configured for dial-in mode, the telephone number listed would be delivered to the user as the telephone number to dial to initiate an audio session. For digital telephony trunks (T1 or E1 at present) that have the same telephony number or extension for all ports (24 in the case of a T1) the telephone number is repeated or omitted for each subsequent board/port combination. If the telephone number is omitted, it is assumed that the most recent previously specified telephone number is to be used for the port in question. If the audio server is in VoIP mode, only entries that do not correspond to boards used for VoIP mode are actually processed. For boards configured for digital interfaces (T1 or E1), it is not normally possible to give each port a unique identifier (such as a telephone number) as these identifiers are shared across all ports (hunt group, etc.). In dial-out mode this is not an issue as the first unused port is simply used to initiate the connection (VoIP or telephony). In the case of in-bound connections (dial-in mode), it is not possible to know ahead of time on which physical port the call will arrive. In this case, the audio server maintains a list of expected connections. If any connections are expected, incoming calls are answered, and the access codes entered are compared with the expected access codes. If there is a match, the call is allowed to complete. If not, the call is rejected (dropped or disconnected.) Digital connections (T1 or E1) can be programmed to provide a direct inward dial number (DID) for each inbound call. In this case the audio server can be configured to expect certain DID number for each T1 or E1 trunk. These DID number can be given to users to dial in on (if configured in dial-in mode). If incoming calls contain previously reserved DID numbers the audio server will answer the call. If the incoming call does not contain a previously reserved DID number the call is rejected. The difference between using DID numbers and not is that with DID numbers that call only has to be answered if it is originating on a reserved DID number. If DID numbers are not used the call has to be answered and the user prompted for their access code before it can be determined if this is a legitimate call. Incoming connections are also dropped if no connections are expected and the port or audio server is not configured for private ports.

Inventive Interface Software

In accordance with the present invention, one can access and control audio files of embodiment 1000 with any software that can run inside or outside of a web browser environment on a user's computer. Inside the web browser environment, standard HTML pages or Netscape plug-ins (Macromedia Flash, etc.) or Microsoft ActiveX controls can all have access to the audio feature set. Outside the web browser environment, preferably, any software that can emulate a web browser while making requests to a web server with web server add-in components 150₁-150ₙ installed, can use and control the inventive audio environment. In further embodiments of the present invention, a direct interface to control server 300 can enable use of the audio feature set without having to run inside a web browser. This interface can be initiated by using a software library linked into the user's application, or by sending correctly formatted messages directly to the control server (via its wire protocol), and responding to the messages the control server sends back.

In a preferred embodiment of the present invention, an inventive Java applet (isound.class) or an ActiveX control (isound.dll) and its associated inventive Javascript, VB Script, or ECMA script, runs in each web page to be enabled with inventive functionality. In the preferred embodiment, it uses standard HTTP requests and responses to communicate with web server add-in components150₁-150ₙ located at web site 10. Because of the use of HTTP and its associated TCP overhead, it is preferable to minimize the number of connects/disconnects (use HTTP keep-alive header) and to keep requests and replies small (single network packet).

In a preferred embodiment of the present invention, the inventive Java Applet (isound.class) is designed to run in any Java Virtual Machine (JVM) running at JDK 1.0.2 or better. The inventive ActiveX control (isound.dll) is designed to run in Internet Explorer V3.0 or better. Neither has a visual interface other than being able to set its background color. Their sole purpose is to relay commands and audio play/set requests to web server add-in components 150₁-150ₙ running at embodiment 1000. JavaScript or VBScript dedicated to visual animation (not to be confused with the command/request JavaScript or VB Script described below) running in the invention-enabled page calls the inventive Java applet or ActiveX control methods to process commands and requests. Two available functions of the inventive Java applet or ActiveX control are playAudioFile (takes the audio file and appropriate extension URL as an argument) and processCommand (takes the command as argument). An additional function of the inventive Java applet or ActiveX control is called internally when the applet's or ActiveX control's stop method is called. The applet's or control's stop method is called at the following times: (a) the web page where the applet or control is running is being destroyed and (b) the web page where the applet or control is running is being minimized. In either case, this internal method calls embodiment 1000 to stop the playing of audio files.

In addition to the inventive Java Applet or ActiveX control, the same functions can be accomplished by having “invention controlling” JavaScript or VBScript embedded in the web page “Visit” URLs which correspond to the commands or correspond to audio files to be played. The normal technique is to use the JavaScript Image object (the Image object can be used to retrieve any content, not just images) and set its source (.src property) to the URL to be retrieved (“visited”). For example, to pause the audio the following JavaScript sequence might be used.

var pauseISound=new Image( );

pauseISound.src=‘/isound/commands/pause’

The Java applet or ActiveX control method is normally preferred as it gives more control as to the request /response process. The JavaScript or VB Script method is intended only for browsers which do not support Java or JavaScript calling Java applet or ActiveX control methods. The only current known Java-capable example of this is Microsoft Internet Explorer running on the Macintosh.

The following is a sample configuration of the inventive Java applet in an HTML file (web page content). In this example, the inventive applet (isound.class) is located in the /isound/client directory off of the web server root directory.

<applet name =“isoundA” code=“isound.class” codebase=“/isound/client” width=“1”
height=“1”>

<param name=“ isoundCommandsURL” value=“/isound/commands”>
<param name=“ StopAudioCommand” value=“eject”>

</applet>

In this case the user's web browser is told to load the applet (isound.class) from the /isound/client directory off of the web server root directory. The web page that contains this code can be anywhere in the web server document root directory or one of its subdirectories.

The applet has two optional parameters: isoundCommandsURL and StopAudioCommand. isoundCommandsURL defines the location of the inventive audio commands directory relative to the web server root. The default value is: “/isound/commands”. If this is the location used on a web server, it does not need to be specified. StopAudioCommand is the inventive audio command to issue when audio is to be stopped if the user is leaving a page or the page is being minimized. The idea is to stop audio automatically when the user leaves the location where it is appropriate. The default is “eject” if no value is specified.

The inventive controlling JavaScript or VBScript performs similar functions. A code sample is as follows:

```
function isoundProcessCommand(isoundCommand) {
  var now, URLToVisit, dummy;
  var theApplet = null;
  if (useApplet == true) {
  if (isIE == true) {
    document.isoundControllerID.processCommand(isoundCommand);
  } else {
  theApplet = document.layers[‘appletsL’].document.applets [‘isoundController’];
  theApplet.processCommand(isoundCommand);
  }
  } else {
    now = new Date( );
```

URLToVisit = new Image( );
URLToVisit.onerror = null;
URLToVisit.src = isoundCommandRoot + ‘/’ + isoundCommand + ‘?’ + now.getTime( )

+ document.location;
}
}

The function isoundProcessCommand takes the inventive command to execute as a parameter. If the web page is to use Java applets' methods for control, the applets are called. If the web page is not to use the applet, a JavaScript Image object is constructed to “access” the appropriate isound command URL. Note that appending a question mark plus the value of the current time in seconds since Jan. 1, 1970 via the now.getTime( ) function call always forms a unique query string. This is to insure that the web browser does not use a cached response to a previous “access” of the same isound command URL. This should not normally be necessary as all requests to web server add-in components respond by telling the web browser, and any intervening equipment such as proxy servers, not to cache the response (uses pragma : no-cache and sets the expiration date to a time in the past). Unfortunately since some of these devices do not function as specified; the unique query string forces the web browser to access the web server each time the request is made as the number of seconds since Jan. 1, 1970 is constantly changing. The document.location reference appends the filename of the current web page to the request. This value is used by the web server add-in component and the control server to determine if the command is from the same page as the original audio file play or set request (below).

```
function isoundPlayAudioFile(isoundAudioFile) {
  var now, URLToVisit;
  var theApplet = null;
  if (useApplet == true) {
  if (isIE == true) {
    theApplet = document.isoundControllerID;
    theApplet.playAudioFile(isoundAudioFile);
  } else {
    theApplet = document.layers[‘appletsL’].document.applets[‘isoundController’];
```

theApplet.playAudioFile(isoundAudioFile);

```
  }
  } else {
    now = new Date( );
```

URLToVisit = new Image( );
URLToVisit.onerror = null;
URLToVisit.src = isoundAudioFile + ‘?’ + now.getTime( ) + document.location( );

}
}

The function isoundPlayAudioFile takes the inventive audio file to play as a parameter. If the web page is to use Java applets' methods for control, the applets are called. If the web page is not to use the applet, a JavaScript Image object is constructed to “access” the appropriate isound command URL. Note that appending a question mark plus the value of the current time in seconds since Jan. 1, 1970 via the now.getTime( ) function call always forms a unique query string. This is to insure that the web browser does not use a cached response to a previous “access” of the same isound command URL. This should not normally be necessary as all requests to web server add-in components respond to tell the web browser, and any intervening equipment such as proxy servers, not to cache the response (uses pragma: no-cache and sets the expiration date to a time in the past). Unfortunately since some of these devices do not function as specified; the unique query string forces the web browser to access the web server each time the request is made as the number of seconds since Jan. 1, 1970 is constantly changing. The document.location reference appends the filename of the current web page to the request. This value is used by the web server add-in component and the control server to determine if a command is from the same page as the original audio file play or set request.

Blended Background

In accordance with one embodiment of the present invention, which embodiment is useful for components embedded in web pages, a user application sets its background color to blend into the web page. This enables all components embedded in web pages which do not have any visual interface to blend into web pages, and not cause themselves to be noticed thereon.

Enterprise, Workgroup, and Developer Configurations

Embodiments of the present invention have three configurations: (a) enterprise (corresponding to embodiment 1000 shown in FIG. 1 and described in detail above); (b) workgroup; and (c) developer. All configurations (embodiment 1000 shown in FIG. 1) utilize computer telephony boards using a PCI bus interface to insure maximum capacity and throughput. Advantageously, PCI based boards allow a large number of boards to be installed in each audio server. In addition, users can record messages for later follow-up. Additionally the enterprise configuration integrates with call-center products to allow the user to “transfer” to a live person when and where appropriate. As described above, the enterprise can perform live monitoring and live re-configuration.

The workgroup configuration comprises two web servers and two audio servers. Each audio server in the workgroup has a maximum of two computer telephony boards installed. If these boards are digital, for example, T1, E1, ISDN, only one trunk per board is supported. This provides a maximum configuration of 96 ports in the United States where T1 trunks (24 ports per T1) are in common use. Additionally the workgroup edition does not have the capability to integrate with call center products to provide a transfer to a live person where applicable, however, the workgroup is capable of live monitoring, but not live reconfiguration.

In the developer configuration, all components, the web-server add-in components, the control server, and the audio servers all run on the same machine. Thus, the developer can only provide audio capability to a single web server at a time. One computer telephony board is all that is supported. If the selection is for a digital interface, for example, T1, E1 or ISDN, only one such trunk is supported. This allows for analog line ports counts of 4 or 8 ports; or digital line counts of 24 or 30 ports (T1 or E1). No matter how many physical ports are installed the developer configuration can only have two ports active at the same time. The developer configuration does have the capability to integrate with call center products to provide a transfer to a live person where applicable for testing. The developer edition is capable of live monitoring, but not live reconfiguration.

For example, although some embodiments of the present invention comprise components that run on different processors or computers, it is within the spirit of the present invention for some or all of the above-described components to be implemented as software modules that run on the same hardware. Further, although the web server add-in components were depicted as being separate, but associated with a web server, it should be clear to those of ordinary skill in the art that a web server may be embodied in a form to include a web server add-in component as a part thereof.

Stand-Alone Player

In accordance with one embodiment of the present invention, an inventive player is installed on a user machine or appliance, which player takes compressed multimedia content delivered via, for example, a network and plays it back at normal speed, or at any speed dictated by the user. In accordance with this embodiment of the present invention, the compressed presentation can be delivered: (a) in whole or in chunks; (b) live (for example, as a web request); or (c) as an e-mail attachment. Further, in accordance with one embodiment of this aspect of the present invention, the presentation contains multimedia content, thus no telephone call or VoIP session is required. If the user wants to connect live to a call center or to a person referenced, for example, within the presentation, the connection can be made using, for example, and without limitation, H.323 or other VoIP protocols such as Session Initiation protocol—(SIP) or media gateway protocol (MGCP). In most cases, Real Time Protocol (RTP) and real time control protocol (RTCP) are used to transmit the actual audio. Further, the player can be a standalone application, or it can be integrated into a web browser or an e-mail client using technologies such as, for example, Java or ActiveX. The compression/decompression algorithms can be any one of a number of compression/decompression algorithms that are well known to those of ordinary skill in the art.

As has been discussed above, one aspect of the present invention comprises a computer or an Internet appliance (embodiments of both are well known to those of ordinary skill in the art) which is connected to a data network (for example, and without limitation, the Internet and an internal Intranet) running a visual display application (for example, and without limitation, a web browser such as Netscape Navigator or Microsoft Internet Explorer) and a telephone (of any type) for playback of audio connected to the public telephone network (“PSTN”) or an internal telephone network such as (for example, and without limitation, an internal telephone network provided by a private business or branch exchange (“PBX”) or a Voice,over Internet Protocol (VoIP) network (Internet or intranet)). As is well known to those of ordinary skill in the art, a web browser is a computer hardware/software/firmware application capable of processing and displaying information encoded in, for example, HTML, DHTML, VRML. SGML and XML languages. It is noted that the terms computer or Internet appliance is used in the broadest sense, including the manner in which the terms are known to those of ordinary skill in the art. It is further noted that the term data network is used in the broadest sense, including the manner in which the term is known to those of ordinary skill in the art. It is still further noted that the term visual display application is used in the broadest sense, including the manner in which the term is known to those of ordinary skill in the art. It is yet still further noted that the term telephone is used in the broadest sense, including the manner in which the term is known to those of ordinary skill in the art.

It should be noted that the present invention, in its broadest aspect, combines two or more separate networks into a unified tool for multimedia information delivery. In other aspects of the present invention, the unified tool provides at least an aspect (for example, a visual aspect) of the multimedia information over one of the separate networks and provides at least another aspect (for example a visual aspect) of the multimedia information over another one of the separate networks. In still other aspects of the present invention, the unified tool provides synchronized multimedia information delivery over the two or more separate networks.

Although embodiments of the present invention have been described wherein one of the media comprises visual display provided over a data network and another one of the media comprises audio display over a telephone network, it should be understood that the present invention is not limited to this. For example, it is within the spirit of the present invention to include embodiments wherein audio networks include radio or wireless or the Internet (VoIP for example). Additionally, the present invention contemplates use of other networks for multimedia transmission in the broadest sense of the term such as, without limitation, cable television, satellite networks and so forth. It should be clear to those of ordinary skill in the art how such further embodiments may be implemented by one of ordinary skill in the art without undue experimentation with reference to the detailed description set forth above.

It is within the spirit of the present invention that further embodiments include: (a) recording of information transmitted by users to the audio servers over the telephone network (in accordance with methods that are well known to those of ordinary skill in the art); (b) enable transfer of a user to a live operator or acceptance of user commands, by capture of commands issued over the telephone network by key presses of the telephone pad (in accordance with methods that are well known to those of ordinary skill in the art), and/or by capture of voice commands issued over the telephone network by voice recognition mechanisms (in accordance with methods that are well known to those of ordinary skill in the art), and/or capture of data commands issued using action request forms transmitted by the user's web browser. Lastly, in accordance with some such embodiments, it is contemplated that embodiment would cause information to be displayed on the user's computer screen in response to the user input.

Lastly, it is within the spirit of the present invention that the above-described embodiments (wherein interaction between, for example, a user appliance and an audio-capable apparatus produces multimedia presentations) include interactions involving user appliances such as, for example, wireless appliances (for example, wireless telephones) or other appliances having limited capacity displays such as, for example, small LCD screen displays. In addition to interactions that have been described above for controlling presentation of content (visual as well as audio), embodiments of the present invention, including embodiments described in detail above, include interactions wherein interactions for controlling the presentation are performed by audio. For example, to control presentation of audio files, the interaction can entail predetermined sequences of keypresses which produce audio (via a keypad on a telephone) or one spoken commands. The audio input can be analyzed in accordance with any one of a number of methods that are well known to those of ordinary skill in the art (including voice recognition techniques) to produce commands that can be provided to audio servers and/or or web server add-in components. Such audio input analysis can be provided, for example, by an audio server or by processing power or equipment available to an audio server. In accordance with such embodiments, such interactions can also be used to direct the display of visual content as well as audio content. For example, such audio commands can be used to direct the display to portions of visual content having numeric or alphanumeric designations or to subjects (interpreted by, for example, voice recognition techniques).

Features of Embodiment 2000 That Will Be Referred to Generally as IntenseConference and IntenseChat

In accordance with one embodiment of the present invention, a user can create a conference call without using a dedicated operator or service. In particular, to do this in accordance with the present invention, the user uses a local application (or a web browser based application) to list participants in the conference call in accordance with any one of a number of methods that are well known to those of ordinary skill in the art. As an option, the list may specify whether the participants are to be called, or whether they will call-in. The list may further specify the date and time of the conference call. Next, in accordance with this embodiment, the participants' telephone numbers, voice mail addresses, and/or e-mail addresses are keyed-in or looked up from a database accessible from the embodiment (for example, a local database, a database integrated with a contact manager, a corporate database, and so forth). Next, each participant is notified of the conference call particulars via e-mail and/or voice mail in accordance with any one of a number of methods that are well known to those of ordinary skill in the art. In particular, for the case of voice mail, a notification telephone call can go to a direct voice mail extension for the participant, or to the participant's normal telephone line. If the notification telephone call goes to the participant's normal line, and the participant answers, the participant is asked: (a) whether he/she wants to hear the conference call particulars at that time; (b) whether the conference call particulars should be forwarded by e-mail; or (c) whether the embodiment should call back in a moment to leave the conference call particulars (in which case the called participant will know not to answer the call, and let it go into voice mail). Further, the user can have the notification telephone call and the conference call directed to a different telephone number, if desired; in which case the different telephone number can be transmitted at that time. In accordance with this embodiment, a copy of the conference call can be created and stored in a file, and a transcription of the copy may be created, if requested, prior to setting up the conference call or during the call, by providing predetermined signaling over the telephone connection. In either case, the resulting copy may be transmitted to the user, for example, at a predetermined voice mail address, the transcription may be delivered to the user, for example, at a predetermined e-mail address, or the user may access the copy or the transcription directly by accessing the system for delivery. Still further, written material can be read during the telephone conference call using any one of a number of text to speech (TTS) methods that are well known to those of ordinary skill in the art. In accordance with this embodiment, commands to the conference call system can be given via voice input, or via input using a telephone keypad, or via input using a computer keyboard. During the conference, participants can view a computer interface, for example provided at a web site, to determine which participants are connected. A participant would access the web site and obtain a list of present participants and a list of all potential participants. A command button would be used by a user who wishes to participate. The command would be received, for example, an IntenseConference add-in and transmitted, for example, in turn, to a web server add-in component. The web server add-in component would place an appropriate request with an audio server. Lastly, in accordance with this embodiment, keyboard input received from a keyboard-only-user can be converted to speech using any one of a number of text to speech (TTS) methods that are well known to those of ordinary skill in the art, and likewise audio content can be transcribed to text for keyboard-only-clients using any one of a number of voice recognition methods that are well known to those of ordinary skill in the art.

In accordance with a variation of the above-described embodiment of the present invention, a chat can be set up in a manner similar to that described above with respect to setting up a conference call. The chat setup is advantageously used to set up ad-hoc conference calls, i.e., not pre-arranged calls like conference calls. In accordance with this embodiment, keyboard input received from a keyboard-only-user can be converted to speech using any one of a number of text to speech (TTS) methods that are well known to those of ordinary skill in the art, and likewise audio content can be transcribed to text for keyboard-only-clients using any one of a number of voice recognition methods that are well known to those of ordinary skill in the art.

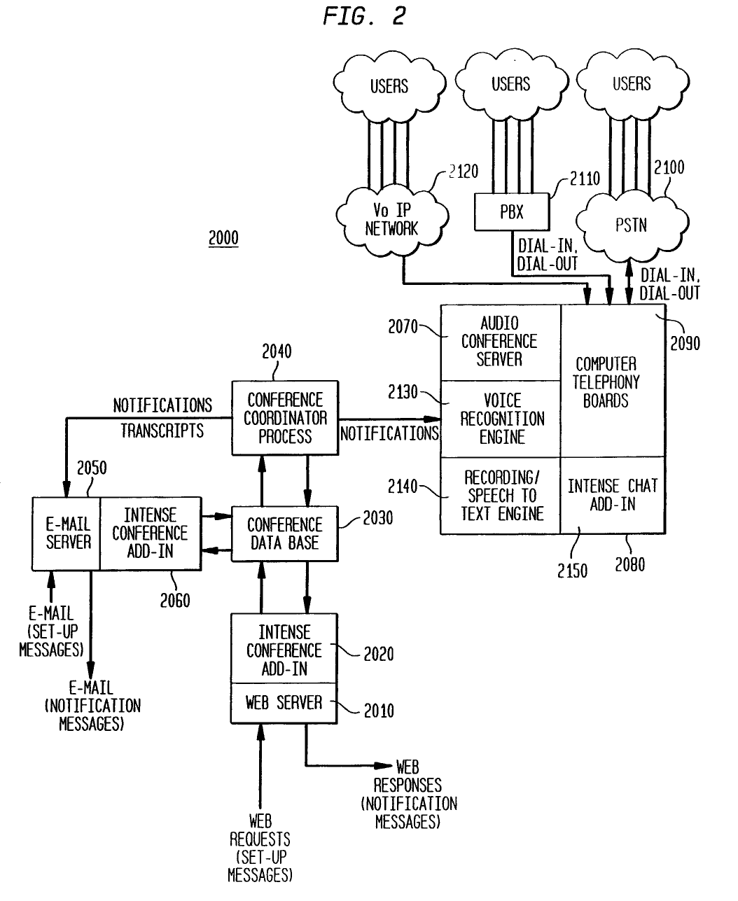

FIG. 2 shows a block diagram of a web site that is enhanced by embodiment 2000 of the present invention to provide the above-described features; referred to below as IntenseConference and IntenseChat. As shown in FIG. 2, web site 2010 is enhanced with IntenseConference add-in 2020 which receives requests from users over a network, for example, the Internet and/or an Intranet, to set up and/or attend and/or determine the status of a conference call. As further shown in FIG. 2, IntenseConference add-in 2020 receives a list of participants from a user, which list may specify, among other things, whether the participants will be called to set up the conference or whether they will call in to the conference. As an option, IntenseConference add-in 2020 may access a data base (for example, a company data base) to obtain participants' telephone numbers, voice mail addresses and/or e-mail addresses (these data may also be submitted with the list by the user). As further shown in FIG. 2, IntenseConference add-in 2020 updates conference data base 2030. As further shown in FIG. 2, conference coordinator process 2040 refers to conference data base 2030 to transmit conference notification messages to e-mail server 2050. Then, e-mail server 2050 transmits e-mail notification messages to the conference attendees. As further shown in FIG. 2, e-mail server 2050 may also be enhanced with IntenseConference add-in 2060 which, like IntenseConference add-in 2020, receives requests from users to set up and/or attend a conference call. IntenseConference add-in 2060, like IntenseConference add-in 2020, updates conference data base 2030. As further shown in FIG. 2, conference coordinator process 2040 refers to conference data base 2030 to transmit conference notification messages to audio conference server add-in 2070 in audio server 2080. Audio server 2080 then sends voice mail notification messages to conference attendees.

In order to effectuate the conference, prior to the set-up time, IntenseConference add-in 2020 obtains relevant conference information such as, without limitation, topic, user names, telephone connection information, and so forth from conference data base 2030. The conference information is then transmitted to conference server 2070 in audio server 2080. Audio server 2080 utilizes equipment such as, for example, computer telephony boards 2090 to place calls to, or receive calls from, the conference attendees, for example, over PSTN 2100, through PBX 2110, over a network VoIP 2120, and so forth to create a conference connection. As shown in FIG. 2, conference server 2070 may comprise voice recognition engine 2130 and/or recording/speech-to-text engine 2140 for use in a manner that was described in detail above. Various transcriptions may be saved, for example, in conference data base 2030 for later access and/or retrieval using IntenseConference add-in 2020 or 2060 as an intermediary. It should be understood that any part of the audio portion of the conference may be converted to text by using speech-to-text engine 2140 for transmission to an attendee who cannot, for example, perceive the audio. In this case, the user may connect to a data port on audio server 2080. Likewise, a user may enter text on a keyboard, transmit it to audio server 2080 through the data port, and a text-to-speech engine will convert it to speech. Similarly, a document may be converted to speech for use in the conference, by, for example, having conference server 2070 retrieve it from conference data base 2030. Lastly, users may interact with IntenseConference add-in 2020 during the conference to obtain information such as, for example, participant status.

As further shown in FIG. 2, IntenseChat add-in 2150 enhances audio server 2080 to enable users to dial-in to a common connection for an on-going conference.

Features of Embodiment 3000 That Will Be Referred to Generally as IntenseDetour

In accordance with one embodiment of the present invention, predetermined web sites and/or predetermined directories of predetermined web sites are masked so that predetermined users cannot access content contained therein. In accordance with this embodiment, a mask can be used (a) to exclude from viewing or (b) to permit viewing of content by predetermined organizations or predetermined personnel in predetermined organizations. In accordance with one such embodiment, for example, a list of users whose output is masked is maintained so that it is accessible by, for example, a web server add-in component or by a control server with which a web server add-in component communicates. For example, in accordance with this one such embodiment, a user can be specified, for example, to receive: (a) no content, (b) different content from other users, or (c) targeted content. Advantageously, in accordance with this one such embodiment, a predetermined user may be easily detected when he/she attempts to connect from an office because, for example, his/her IP address is associated as having been registered to the predetermined user. In this case, “undesirable” users may have their access screened. However, a problem may arise if the undesirable user, for example, goes home with his/her computer, and connects via an ISP from which he/she cannot be detected because he/she used an IP address that is different from the registered one. To solve this problem, in accordance with one aspect of this one such embodiment, whenever a request for content first comes from an “undesirable” user, he/she is sent an identifier by, for example, a web server add-in component, the identifier being, for example, an HTTP cookie, which identifies him/her as such. The identifier could be generated by any component such as a control server, or could be obtained from any other system with which the inventive embodiment can interact. This cookie (received while the user was connected at the office) will be identified whenever he/she tries to connect later (using his/her computer), and he/she will be given the same masked content he/she would have received at the office. Additionally, in accordance with another aspect of this one such embodiment, a list of telephone numbers or telephone number subsets (area code and prefix) is maintained for undesirable users. If an undesirable user is detected via his/her telephone number, he/she is thusly flagged for future requests, and a connection thereto is disallowed. The detection of the telephone number may be made, for example, by a web server add-in component, a control server (see for example, embodiment 1000), or an audio server (see for example, embodiment 1000).

In addition, in accordance with one embodiment of the present invention, a web server add-in can route users to different content based on, for example, browser type and/or unique user identification. Advantageously, this embodiment of the present invention is more efficient and secure than an embodiment that performs a similar function by sending code in the form of the web pages (embodied in HTML, Javascript, and so forth) to make decisions based on browser type or an identification embedded in the user's browser, which decisions are made in accordance with any one of a number of methods that are well known to those of ordinary skill in the art.

In accordance with one embodiment of the present invention, web server response headers can be augmented (for example, the server name/OS name can be changed and/or the response header case can be changed) so that a hacker will not know what type of web server is in use. Advantageously, this makes hacking the web site more difficult.

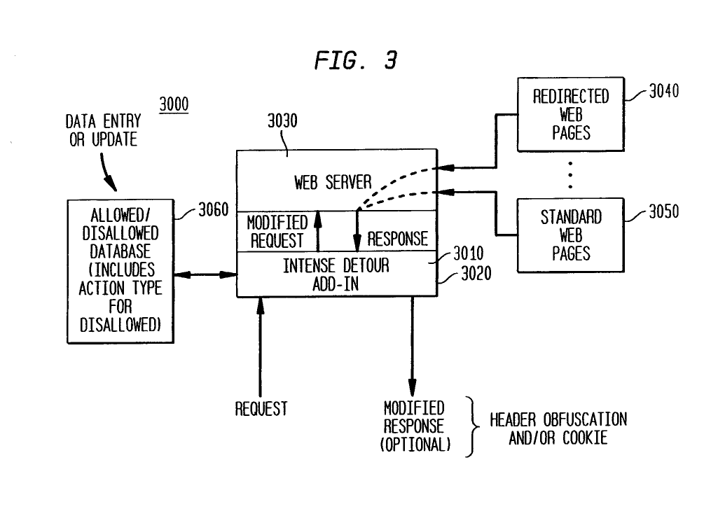

FIG. 3 shows a block diagram of a web site that is enhanced by embodiment 3000 of the present invention to provide the above-described features; referred to below as IntenseDetour. As shown in FIG. 3, IntenseDetour server-side add-in 3010 detects the user's web browser type whenever a request is transmitted thereto to web site 3020. If a more optimal set of content exists for the request, the request is modified to be redirected to the “best” content for the browser. This determination related to “best” content may be based, for example, on predetermined lists. Then, the modified request is transmitted to web server 3030 for retrieval of “redirected” web pages 3040. If there is no modification of the request, the unmodified request is transmitted to web server 3030 for retrieval of standard web pages 3050.

In accordance with one alternative of this embodiment of IntenseDetour, if response headers are to obfuscated, all response headers are modified so that it is not easy to determine the web server or the operating system in use.

In accordance with another alternative of this embodiment of IntenseDetour, predetermined areas (for example, domains) of a network, for example, the Internet and/or an Intranet, are blocked. In this case, IntenseDetour add-in 3010 consults data base 3060 to determine the type of response a user is to permitted to receive. In one alternative of this embodiment, IntenseDetour add-in 3010 sends a cookie that records blocking identification information back to the user. Advantageously, this will enable the user to be blocked even though the user may later connect from an unblocked domain. Appropriate entries in data base 3060 enable selective blocking, for example, to restrict user access to predetermined web sites or to predetermined data bases.

Features of Embodiment 4000 That Will Be Referred to Generally as IntenseID

In accordance with one aspect of the another embodiment of the present invention, an inventive web browser add-in is added to user browser software. The web browser add-in provides a unique user id to identify the user as an individual person and/or to identify the user's browser. The unique user id can be generated using any one of a number of methods that are well known to those of ordinary skill in the art. Whenever the user accesses the web site, the unique user id is transferred thereto and is interpreted by a web server add-in component or the web server itself. The unique user id can then be used to mask content sent to and from web sites the user visits. Alternatively, the unique user ID can be used to allow access to content, or it can be used to provide personalized content. Advantageously, in accordance with this embodiment of the present invention, the user is given control over how he/she is identified to specific web sites and what information is sent to him/her.

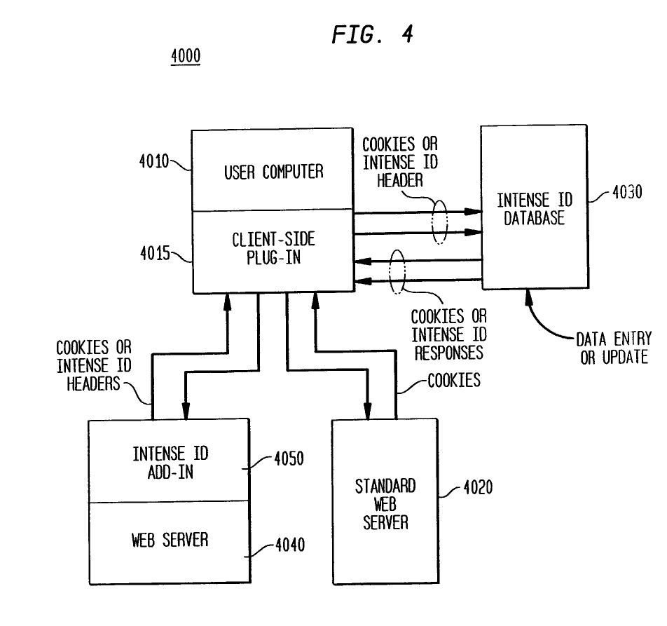

FIG. 4 shows a block diagram of a web site that is enhanced by embodiment 4000 of the present invention to provide the above-described feature; referred to below as IntenseID. As shown in FIG. 4, in accordance with one embodiment of IntenseiD, a user's web browser in a user's device such as, for example, user computer 4010, has been enhanced by client-side plug-in 4015. In accordance with this embodiment of the present invention, client-side plug-in 4015 manages cookies sent from web servers at standard web sites such as, for example, standard web server 4020. Client-side plug-in 4015 manages the cookies to enable the user to control the information that is returned whenever cookies are sent back to the originating web server. Client-side plug-in 4015 does this by storing cookies in IntenseID data base 4030 (for example, associated with client-side plug-in 4015), and by modifying the cookies when they are stored, and/or by modifying the cookies prior to returning them to the originating web server.

As also shown in FIG. 4, in accordance with another embodiment of IntenseID, web server 4040 is augmented with IntenseID add-in 4050. When web server 4040 has been augmented with IntenseID add-in 4050, the user's web browser is notified thereof by, for example, an appropriate notification in, for example, an HTTP header. If the user's web browser does not use client-side plug-in 4015, IntenseID add-in 4050 does not interact with user messages. However, if the user's browser uses client-side plug-in 4015, encrypted messages are sent back and forth between IntenseID add-in 4040 and client-side plug-in 4015. Then, in all following cases, the user controls which information is sent to specific servers and/or specific domains.

If the user enables it, client-side plug-in 4015 will send a unique identifier (generated by the client) to uniquely identify the user. Advantageously, this unique identifier can be used by the web server to uniquely identify users that visit the web site.

Those skilled in the art will recognize that the foregoing description has been presented for the sake of illustration and description only. As such, it is not intended to be exhaustive or to limit the invention to the precise form disclosed.

Features of Embodiment 5000 That Will Be Referred to Generally as IntenseSpeed

In accordance with one embodiment of the present invention, for efficiency and speed of operation, any and all web content can be preloaded before it is needed and/or have its HTTP headers augmented, for example, with Expires and Cache-Control headers to indicate for how long the content is valid. This can be done for all types of web content, whether configured as any one of HTML, Javascript, Java, ActiveX Control, VBScript, ECMA Script, GIF images, JPEG images, PNG images, Macromedia Flash and Director movies, and so forth. In accordance with this one embodiment of the present invention, this functionality is packaged as a server component (which server component, for example, augments headers) and a client component (which client component, for example, requests content pre-loading). Each component is optional, i.e., it is not required that they be used together. For users that only want to pre-load web content, the client component is all that is needed. For web sites that only want to augment headers, but not pre-load web content, only the server component is needed. In accordance with one aspect of this embodiment of the present invention, the pre-loads can be stopped whenever the embodiment detects that the user has chosen a different direction of the web site (or presentation) so that previously requested pre-loads no longer make sense. For example, this may occur whenever the user leaves the web site, or whenever a predetermined number of pre-loaded pages has been reached, or when the user has branched to a predetermined section of the web site, and so forth.

In accordance with one embodiment of the present invention, a user application, for example, the user's web browser, can navigate a web page to a predetermined location when a predetermined number of files have been pre-loaded. This capability can be built into the web browser, or a signal can be sent from the web server that it is doing the pre-loading. This allows a web page author to verify that certain content is in the web browser cache before navigating to a web page that needs it for proper display. This activity can be performed by the pre-loading application, in the form of an applet, an ActiveX control, VBScript, or Javascript, and so forth or the web server add-in component could redirect the user's web browser to another web page after the last requested file of a batch had been sent to the user.

In accordance with one embodiment of the present invention, the applet, for example, can be programmed to start automatically whenever a web page is loaded by the user's web browser, or it can be programmed to start after a predetermined delay. Alternatively, the applet can be programmed so that it will start only after it is sent a command, for example, from a web server add-in component or from other applets, ActiveX controls, VBScript, or Javascript, and so forth. Lastly, the applet can be programmed to pause and resume operation in response to commands sent, for example, from a web server add-in component or other applets, ActiveX controls, VBScript or Javascript, and so forth. Advantageously, this last option enables traffic to be handled over a link to a web site in accordance with a priority scheme to ensure that the link will not be overused when other traffic has higher priority, i.e., traffic such as, for example, audio triggering commands that have higher priority.

Preferred embodiments of the present invention, utilize an inventive method and apparatus for interaction between a web browser and a web server. The inventive method and apparatus are discussed in detail below.

In the prior art, whenever a user's web browser requests information from a web server, the scenario is as follows: (a) the user's web browser requests information from the web server over a network link (one or more Internet links and/or one or more Intranet links); (b) the user's web browser waits for the information to arrive; (c) the user's web browser reads (displays) the information to the user; and (d) the cycle is repeated. The read (display) information step can take quite a long time and, during this long time, the network link back to the web server is dormant. Further, information arriving over the network usually contains large amounts of “dead” time, i.e., dead time from a computer's perspective. Web sites are also contracting for network capacity regardless of whether it is actually used or not. This unused bandwidth could be used to provide a better experience for its customers.

As a result of the above, given their understanding that current information transmission techniques involve substantial network delays, most web authors create web pages with a great deal of information. This is done, so that a user is rewarded with a great deal of information to offset his/her dislike for the wait he/she will most likely experience in obtaining that information. Unfortunately, it can take a great deal of time to fully absorb all the information on these crowded web pages.

As one can readily appreciate from the above, a need exists in the art for method and apparatus for efficient information transmission between user interfaces such as, for example, web browsers and web servers.

In addition to above-identified problem of obtaining information from a web server, whenever a user requests that information be re-displayed, in accordance with the prior art, the user's web browser will ask the originating web server if it is safe to use a local copy of the information or whether there is a need to have the web server re-send the information. As one can readily appreciate from this, a network “conversation” must take place between the user's web browser and the originating web server for each piece of information to be re-displayed.

As one can readily appreciate from the above, a need exists in the art for method and apparatus for efficiently utilizing information to reduce and/or eliminate network conversations arising due to re-display requests of previously requested web content.

Embodiments of a first aspect of the present invention (relating to interaction between a user interface such as, for example, a web browser and a web server) advantageously satisfy the above-identified need in the art and provide method and apparatus for efficient information transmission between user interfaces such as, for example, web browsers and web servers. Advantageously, embodiments of such method and apparatus will enable web site authors to develop web sites having series of screens with logical flows that better present information. Further, such efficient information transmission will enable a user to progress from screen to screen to obtain desired information without delays. In accordance with one embodiment of a method in accordance with the first aspect of the present invention (relating to interaction between a user interface such as, for example, a web browser and a web server), whenever information is first requested from a web server by a user interface such as, for example, a user's web browser, the web server transmits the information to the user and the user stores (pre-loads) the information in the web browser's local storage, i.e., “cache”, or other storage that is accessible by the web browser. Further, in accordance with a preferred embodiment, such transmission occurs in the background before the information is needed by the web browser for display to the user.

Embodiments of a second aspect of the present invention (relating to interaction between a user interface such as, for example, a web browser and a web server) advantageously satisfy the above-identified need in the art and provide method and apparatus for efficiently utilizing information to reduce and/or eliminate network conversations arising due to re-send requests. In accordance with the second aspect of the present invention (relating to interaction between a user interface such as, for example, a web browser and a web server), the web server gives information an expiration date and time. Then, when the information is needed for display, the user's web browser displays it from the stored copy as long as the date and time, at the time of display, is earlier than the expiration date and time of the copy. Advantageously, embodiments of the second aspect of the present invention (relating to interaction between a user interface such as, for example, a web browser and a web server) minimize network bandwidth requirements for a web user.

As one can readily appreciate from the above, embodiments of the present invention (relating to interaction between a user interface such as, for example, a web browser and a web server) are advantageous in that the same network connection can be used to transfer multiple files if the file size for each is known instead of destroying and recreating the connection for each requested file. Since destroying and creating and destroying connections is very expensive in terms of network and time requirements; elimination of these steps enables the same network to support many more users without requiring expensive upgrades. In addition, there is less loading on web servers that provide information, thereby enabling them to support many more users without requiring expensive upgrades or additional servers.

Pre-load

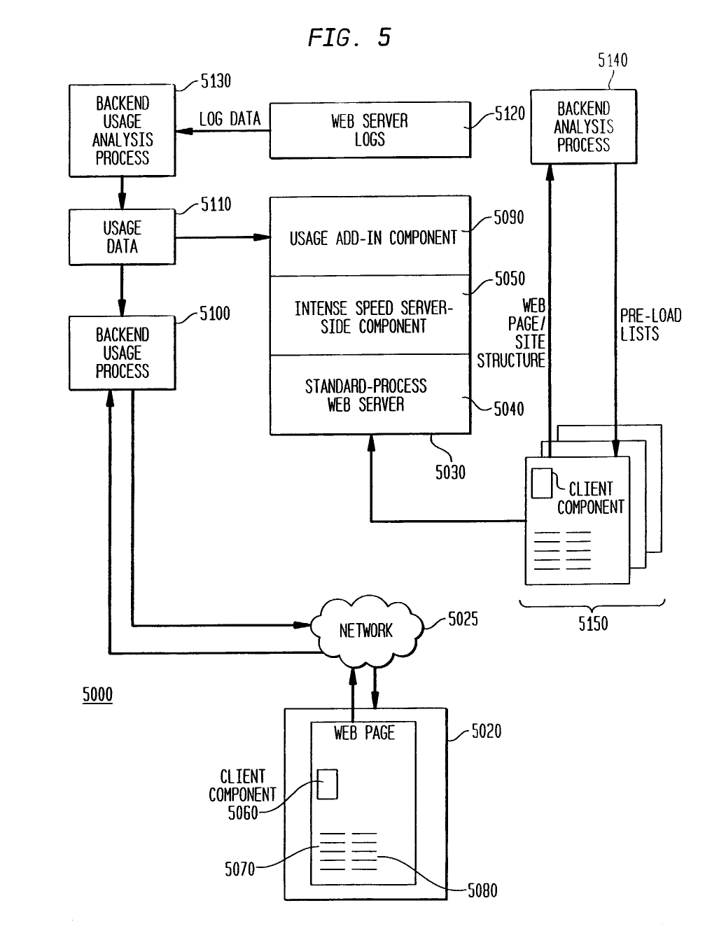

A preferred embodiment of the present invention (relating to interaction between a user interface such as, for example, a web browser and a web server) is embodied in two inventive components. As shown in FIG. 5, in the preferred embodiment, first component 500 is implemented as a Java applet or ActiveX control that is downloaded from a web server (for example, web server 100₁) and runs in Java or ActiveX control enabled web browser 25, for example, Netscape Navigator/Communicator or Microsoft Internet Explorer. First component 500 requests files from the web server and verifies that they are loaded into a cache associated with the user's web browser. In accordance with the preferred embodiment of the present invention (relating to interaction between a user interface such as, for example, a web browser and a web server), the Java applet or ActiveX control has no visual interface, i.e., all of the tasks it performs occur in the background.

In accordance with this embodiment of the present invention (relating to interaction between a user interface such as, for example, a web browser and a web server), an embodiment of first component 500, for example, the inventive Java applet or ActiveX control, is included in any Hyper Text Markup Language (HTML) document (web page), where needed. A preferred location for first component 500 is a web page that presents the user with many choices (such as, for example, a top level menu), or in the first page of a sequence of pages (such as, for example, a presentation). For placement in a top level menu web page, in accordance with a preferred embodiment of the present invention (relating to interaction between a user interface such as, for example, a web browser and a web server), the Java applet or ActiveX control is written so that it pre-loads all web pages (and embedded images therefor) for each choice that a user might likely make. For placement in the first page of a sequence of pages, in accordance with a preferred embodiment of the present invention (relating to interaction between a user interface such as, for example, a web browser and a web server), the Java applet or ActiveX control is written to pre-load all following pages (and embedded images therefor). As a practical matter, care should be taken not to load too many pages/images as this may actually decrease performance and give erroneous readings as to which sections of a web site have been visited by a user. The web content to be preloaded can be specified directly by the author of the web site, it can be determined automatically from web site logs, or it can be determined by a combination of the two.

In operation, first component 500 contains the names of files for example, up to 100 files, (for example, as applet parameters) to request from the originating web server that transferred it to the user's web browser. These file names can be specified directly or they can be set by other components of, for example, embodiment 1000 (see the description below in connection with FIG. 5) that analyze web server log files and insert the appropriate filenames in the appropriate files. For example, if ten (10) pages are normally accessed from a given page, the web site author can determine this fact, and enter the ten (10) filenames as a parameter (filexx) to the IntenseSpeed Java applet or ActiveX control; or a web server add-in component can perform the web site log analysis and enter the filenames to pre-load as parameters (filexx) to the pre-loading Java applet or ActiveX control. This task can be performed using any one of a number of methods that are well known to one of ordinary skill in the art of analyzing web server logs.

In accordance with the preferred embodiment, the Java applet or ActiveX control can normally only request files from the originating web server because of Java and ActiveX security requirements. In accordance with a preferred embodiment, the Java applet or the ActiveX control then requests the files from the originating web server, one at a time, by a separate execution thread (threading is optional). The separate execution thread is used preferably to verify that the file requests only occur in the background, and do not slow the web browser as it displays requested web pages. Additionally, the user's web browser can tell the Java applet or ActiveX control to continue requesting files even though the page where the Java applet or ActiveX control is running is being destroyed. In this manner, the Java applet's or the ActiveX control's requesting thread can be told to continue requesting files until it is done, no matter what the user has requested. In response to the requests, in a preferred embodiment, the requested files are loaded into the web browser's local storage (cache) because browser (uniform resource locator) URL methods are used or Winlnet functions are used (in an ActiveX implementation). It is also within the scope of the present invention (relating to interaction between a user interface such as, for example, a web browser and a web server) to transfer the files using lower level TCP/IP protocols from within the Java applet, but by doing this, the user's web browser would not know to load the transmitted files into its cache without taking further action. Such further action may be implemented in accordance with one of many methods which are known to those of ordinary skill in the art. Only by using built-in web browser URL methods or Winlnet methods is one assured (without taking further action) that the requested files will be loaded into the cache, and thus be available to the user's web browser when it is subsequently asked to display them. In accordance with the preferred embodiment, the Java applet is complied with any JDK 1.0.2 or better compiler such as those supplied by Sun, Microsoft or Symantec, and the ActiveX control is compiled with Microsoft Visual C++, Visual Basic, or the equivalent.

Time Dates

In a preferred embodiment of the present invention (relating to interaction between a user interface such as, for example, a web browser and a web server), second component 600 is a module that is integrated with the web server providing the files requested by the user's web browser. Second module 600 sets an expiration date and time of static files and provides further performance enhancing information. The structure and application programming interface (API) of this web server side second component 600 changes based on the type of web server in use. For example: (a) with Netscape Enterprise and FastTrack web servers, second component 200 is implemented as a Netscape Application Programming Interface (NSAPI) add-in; (b) with Microsoft's Internet Information Server (IIS), second component 600 is implemented as an Internet Server Application Programming Interface (ISAPI) add-in; and (c) with Apache from the Apache group, second component 600 is implemented as an Apache module following the specifications of the Apache module API (C-API). In all cases, it is preferred (but not required) to implement second component 600 using the C++ programming language. On Microsoft platforms, Microsoft's Visual C++ is the preferred compilation language and environment and on Unix or Linux platforms, GNU C/C++ is the preferred compilation language and environment.

In accordance with the present invention (relating to interaction between a user interface such as, for example, a web browser and a web server), for each static request that arrives at the web server, second component 600 inserts, for example, a Hyper Text Transfer Protocol (“HTTP”) “Expires” header for a certain date/time in the future (the “expiration date/time”), and optionally includes other performance enhancing HTTP headers that the web server does not normally include for static files. In practice it is usually best to set the expiration date/time to at most a day in advance.

In operation, files specified as parameters to the inventive Java applet or ActiveX control are all requested soon after the web page using the inventive applet or ActiveX control is loaded by the user's web browser. From that point on, the user's web browser that initiated the request via the inventive Java applet or ActiveX control will not request updated status or try to reload any of the previously requested files until after the expiration date/time or the previously requested files are forced out of the web browser's cache. As should be clear to those of ordinary skill in the art, files can be forced out of the web browser's cache if more files are inserted into the cache than will fit. Note, on some versions of Microsoft's Internet Explorer (MSIE) browser, a verification of status request (HTTP conditional GET) may still occur. This is because of a poor implementation on Microsoft's part, as they did not follow the HTTP specification correctly. However, even with the buggy MSIE implementation, embodiments of the present invention (relating to interaction between a web browser and a web server) are still useful as they instruct MSIE to only perform a conditional get and not just to blindly reload the entire requested file even though it is not needed. The ActiveX implementation of the embodiment of the present invention can work around this limitation which hampers Java applets in an MSE environment. This is because ActiveX controls have direct access to the Wininet functions which control the MSIE browser cache.

The following is an embodiment of first component 500 in the form of a Java applet in an HTML file (web page content). In this embodiment, the applet entitled “ispeed.class” is located in a directory /ispeed/client which is appended to a web server root directory.

<applet name=“ispeedA” code=“ispeed.class” codebase=“/ispeed/client” width=“1” height=“1”>

<param name=“files” value=“26”>

<param name=“file1” value=“/introduction/introduction2.html”>

<param name=“file2” value=“/images/happy_face_{—}1.gif”>

<param name=“file3” value=“/images/happy_face_{—}2.gif”>

<param name=“file4” value=“/images/happy_face_{—}3/gif”>

<param name=“file5” value=“/introduction/introduction3.html”>

<param name=“file6” value=“/images/no_downloads.gif”>

<param name=“file7” value=“/images/no_plugins.gif”>

<param name=“file8” value=“/introduction/introduction4.html”>

<param name=“file9” value=“/images/real_player_download_instructions.gif”>

<param name=“file10” value=“/introduction/introduction5.html”>

<param name=“file11” value=“/introduction/introduction6.html”>

<param name=“file12” value=“/introduction/introduction7.html”>

<param name=“file13” value=“/introduction/introduction8.html”>

<param name=“file14” value=“/introduction/introduction9.html”>

<param name=“file15” value=“/introduction/introduction10.html”>

<param name=“file16” value=“/introduction/introduction11.html”>

<param name=“file17” value=“/images/lightbulb.gif”>

<param name=“file18” value=“/introduction/introduction12.html”>

<param name=“file19” value=“/images/checkbox.gif”>

<param name=“file20” value=“/images/arrow_right.gif”>

<param name=“file10” value=“/introduction/introduction13.html”>

<param name=“file22” value=“/introduction/introduction14.html”>

<param name=“file23” value=“/introduction/introduction15.html”>

<param name=“file24” value=“/introduction/introduction16.html”>

<param name=“file25” value=“/introduction/introduction17.html”>

<param name=“file26” value=“/introduction/introduction18.html”>

<param name=“stop_on_stop_event” value=“true”>

</applet>

In accordance with the present invention (relating to interaction between a web browser and a web server), the web page tells the web browser to load the applet (ispeed.class) from the /ispeed/client directory appended to the web server root directory. The web page that contains this code can be anywhere in the web server document root directory or one of its subdirectories.

In accordance with the above-described embodiment of the inventive applet, the applet loads twenty six files via the files parameter. Further, each file to be loaded is specified by the fileXX parameter. Note that absolute file names (denoted) by the leading slash are required in the above-described embodiment, however it should be clear to those of ordinary skill in the art that embodiments of the present invention are not thusly limited and include embodiment which load files from the same directory or sub-directory of the web page from which the applet is loaded (this is termed relative loading).

Also note the optional “stop_on_stop_event” parameter. If this parameter is specified and its value is true, the applet will stop requesting files be loaded into the web browser's cache after an applet stop event is received. The stop event occurs when the web page is being unloaded from the web browser. If the “stop_on_stop_event” parameter is not specified, loading will continue until complete, even if the page where it is loaded is being destroyed or unloaded.

The following details the steps the Java applet or the ActiveX control takes whenever the user's web browser loads the Java applet or the ActiveX control: (a) read the files parameter to determine the number of files to load; (b) size an array to handle the number of files to be pre-loaded; (c) read the specific filexx parameters and load them into the array at the appropriate index (files are loaded in the order specified); and (d) determine whether the “stop_on_stop_event” parameter is specified with a value of true (if so set an appropriate flag).

The following details the steps the Java applet or the ActiveX control takes whenever the user's web browser starts the Java applet or the ActiveX control: (a) start a downloading thread function to load the files specified in the filename array (see step c above) and (b) exit the start function.

The following details the steps the Java applet or the ActiveX control takes on a stop event, i.e., whenever the user's web browser is destroying or hiding the web page where the applet or control is located: (a) if “stop_on_stop_event” was specified as true, set a flag to tell the loading thread to stop after the next requested file is downloaded and (b) exit the stop function.

The following details the steps the Java applet or ActiveX control takes whenever the user's browser executes the loading function which may or may not run in a separate thread. For each file in the array: (a) form a URL to the originating web server based on the file name/location; (b) tell the user's web browser to use its cache to satisfy the request (if in cache); (c) open the connection to the web server using a Java URLConnection object or WinInet function, respectively; (d) read the file contents into a function local buffer 128 bytes—4 kilobytes at a time and discard buffer contents after each read until all file contents have been read (this step forces the user's web browser to request and download the file into its local cache); (e) after each file, pause a tenth of a second before continuing(optional); and (f) if the stop flag has been set (via the stop event function described in detail above), exit; if not, advance to the next file in the list and continue with step a until all requested files have been attempted.

The following is an embodiment of second component 600. Note that, in accordance with the present invention (relating to interaction between a user interface such as, for example, a web browser and a web server), the specific configuration of second component 600 is different based on the particular web server with which it is associated. Specifically, there are separate embodiments of second component 600 for each supported web server and operating system. This is because each of these web servers takes a different approach to answering web browser requests. For example, a Netscape web server allows optional add-ins such as second component 600 to be called for each request or only for specific requests (based on location or type). A Microsoft IIS Web Server requires an optional code for each request regardless of the location or type of the requested file. This can be mitigated by requesting that the optional code only be called during specific request handling phases. Finally, optional Apache modules can be configured to be called for all requests or just requests for a specific server, document directory or document type. In that case, the Apache modules must be recompiled and relinked for each optional module which is installed.

The following is an embodiment of inventive second component 600 using a Netscape FastTrack Web Server on Microsoft's Windows NT operating system. The file is normally named obj.conf and is located in the web server specific configuration directory. In this example, the web server add-in module, entitled “ispeed.dll” is located in the C:\Program Files\ispeed\bin directory. Configuration command lines specific to the present invention are underlined.

Init fn=flex-init access=“C:/Program Files/Netscape/Server/httpd-adams1/logs/access”

format.access=“%Ses->client.ip% -%Req->vars.auth-user% [%SYSDATE%]\” %Req->reqpb.clf-request%\“%Req->srvhdrs.clf-status% %Req->srvhdrs.content-length% %Req->headers.if-modified-since%”

Init fn=load-types mime-types=mime.types

Init funcs=“ISD-init,ISD-service” fn=load-modules shlib=“C:/Program Files/ispeed/bin/ispeed.dll ”

Init fn=ISD-init expiration delta time=240

<Object name=default>

NameTrans fn=pfx2dir from=/ns-icons dir=“C:/Program Files/Netscape/Server/ns-icons”

NameTrans fn=pfx2dir from=/mc-icons dir-“C:/Program Files/Netscape/Server/ns-icons”

NameTrans fn=document-root root=“C:/Program Files/Netscape/Server/docs”

PathCheck fn=nt-uri-clean

PathCheck fn=find-pathinfo

PathCheck fn=find-index index-names=“index.html,home.html,index.htm,home.htm”

ObjectType fn=type-by-extension

ObjectType fn=force-type type=text/plain

Service method=(GET|HEAD) type=magnus-internal/imagemap fn=imagemap

Service method=(GET|HEAD) type=magnus-internal/directory fn=index-common

Service method=GET type=*_magnus-intemal/* fn=ISD-service

Service method=(GET|HEAD) type=*˜magnus-internal/* fn=send-file

AddLog fn=flex-log name=“access”

</Object>

<Object name=cgi>

ObjectType fn=force-type type=magnus-internal/cgi

Service fn=send-cgi

</Object>

The first underlined line above indicates that the Netscape FastTrack web server is to load the IntenseSpeed dynamic link library (dll) from the specified directory. The Netscape web server is also told to be aware that two functions in this dll (ISD-init and ISD-service) may be called from this dll.

The second underlined line above initializes second component 600 (calls ISD-init) to set a expiration date 240 minutes in advance (four hours) for any static information that is requested via the “expiration_delta_time_parameter”. Also in the above embodiment for Netscape servers, the expiration time applies to all documents (files) in any directory on the web server. However, a preferred embodiment enables the expiration time to be specified on a directory by directory basis if desired. Note that, in the preferred embodiment, for efficiency, this value is initialized once at web server startup time and not for each request. In another embodiment of the second component 600, configuration styles are specified for later reference on a web server-wide or directory by directory basis. These styles specify different expiration times and approaches. The main approaches are based on time of request, time of modification or absolute time. Examples: style1=“ALL request plus two days three hours”; style2=“ALL modification plus two weeks one hour”; style3=“ALL fri Jan. 25, 2001 10:23:12 GMT”. Instead of the keyword ALL, different file types can be specified in Multi-purpose Internet Mail Exchange (MIME) type format (ex: text/html or image/gif”). Each directory where IntenseSpeed is applied would then reference the predefined style. Note that some styles are predefined for common expiration types (for example: 1 week, 1 quarter, etc.).

The third underlined line above calls the ISD-service function just before the built-in Netscape function send-file. Netscape's send-file is called for any static file being sent by the web server. The requirement with Netscape servers is that any dynamic content (changes on each request) be served by some other function. In accordance with the present invention (relating to interaction between a web browser and a web server), the ISD-service function inserts an HTTP “Expires” header and a Cache-Control header in the response (to be actually sent by Netscape's send-file) and then exits. Netscape's send-file then sends the requested file with all the headers (including the recently inserted “Expires” header and Cache-Control headers) back to the requesting user's web browser. The ISD-service function also optionally inserts other headers such as “Last-Modified-Date”, “Content-Length” and “Date” if the web server does not normally send them. For Netscape servers, this is not necessary as Netscape servers send all of this information for each static file request.

Thus, in accordance with the present invention (relating to interaction between a web browser and a web server), second component 600 transmits the following information, or information from which the following information can be derived, along with each file requested by the user's web browser: (a) the size of the requested file; (b) the date and time that the item was last modified; (c) the current date and time according to the web server. Further, other embodiments of first component 500 determine these items of information for files sent from web servers that do not already include this information.

The following details the steps second component 600 takes upon being loaded: (a) determine the future expiration date/time from the appropriate initialization parameter or style; (b) verify this parameter as valid; and (c) set its value in a global value which will persist across all requests.

The following details the steps second component 600 takes for each static request as it arrives: (a) calculate (if not an absolute expiration) and insert HTTP “Expires” and “Cache-Control” headers based on the global value stored in the initialization function above and the current date/time (one of ordinary skill in the art may refer to the IETF HTTP RFC and Microsoft's MSDN library for complete details); (b) insert the “Expires” header and the Cache-Control header into the HTTP response; and (c) determine whether other headers (“Last-Modified-Date, Content-Length, Date”) should be inserted in the response based on a compile time flag . If so, calculate and insert them, otherwise do not.

Although embodiments of first component 500 were described as comprising a Java applet or an ActiveX control, it should be clear to those of ordinary skill in the art that the present invention (relating to interaction between a user interface such as, for example, a web browser and a web server) is not limited thusly limited. For example, embodiments of first component 500 may be embodied in equivalents of applets, many of such equivalents being well known to those of ordinary skill in the art (one example being plugins of all sorts, including, without limitation, Microsoft ActiveX plugins, Javascript, ECMAScript, VBScript). In addition, embodiments of first component 500 may also be embodied in software that is loaded, for example, from the web server and runs in the user's web browser. As should be readily appreciated by those of ordinary skill in the art, the software may be embodied in any suitable language such as, for example, in JavaScript, ECMAScript or VBScript.

FIG. 5 shows a block diagram of a web site that is enhanced by embodiment 5000 of the present invention to provide the above-described feature; referred to herein as IntenseSpeed. As shown in FIG. 5, web page 5010 is displayed on user device 5020 (for example, an appliance or a computer such as a personal computer) by, for example, a web browser. In accordance with embodiment 5000, web page 5010 has been authored to include a Java applet, an ActiveX control, Javascript, VBScript, or a browser plug-in version of an IntenseSpeed client component, IntenseSpeed client component 5060. Whenever a user makes a request to web server 5030 for a web page over network 5025 (for example, the Internet, an Intranet, and so forth) using, for example, a Hyper Text Transfer Protocol (“HTTP”), standard-process web server software 5040 in web server 5030 looks up the request to determine: (a) whether the web page exists, and (b) whether the user is authorized to receive it. Such standard-process web server software 5040 is well known to those of ordinary skill in the art, some examples of which are Netscape, MS IIS, Apache, Domino and so forth. If the requested web page exists, standard-process web server software 5040 transmits the requested page back to user device 5020 over network 5025 using HTTP. If IntenseSpeed server-side component 5050 is installed and configured in web server 5030, IntenseSpeed server-side component 5050 augments the HTTP response headers of the requested web page with expiration, cache-control size, and date headers (where not provided natively by standard process web server software 5040).

The requested web page is displayed by the user's web browser and the IntenseSpeed client component 5060 (for example, a Java applet, an ActiveX control, Javascript, VBScript, or browser plug-in, and so forth) begins to run on user's device 5020. There are many options for embodiments of IntenseSpeed client component 5060. In a first option, IntenseSpeed client component 5060 operates on one or more lists of web content (HTML, DHTML, jpeg, gif, applets, and so forth), for example, list 5070 (a list of web content identifiers) and/or list 5080 (a list of links to web content), to be pre-loaded into the cache of the user's web browser. In accordance with the first option, list 5070 and/or list 5080 is specified: (a) explicitly in web page 5010 by the web page author; or (b) by an external process that analyzes (i) web pages and/or (ii) web server logs at a web site. As shown in FIG. 5, backend analysis process 5140 analyzes web server logs 5120 and/or web pages 5150, and inserts lists of web content identifiers and/or links to web content into web pages 5150 (web pages 5150 being accessible by web server 5030). In a second option, IntenseSpeed client component 5060 contacts a backend server component over network 5025 (for example, usage add-in component 5090 residing in web server 5030 or backend usage process 5100). In response, the backend server component transmits the list of files to pre-load into the cache of the user's web page. As shown in FIG. 5, in one alternative of the second option, the list of files to pre-load is based upon usage data stored in usage database 5110. As further shown in FIG. 5, the usage data obtained from usage database 5110 is generated, for example, by an analysis of web server logs 5120, for example, by backend usage analysis package 5130. As should be clear to those of ordinary skill in the art, all backend processes described above can run on the same machine or on different machines.

As those of ordinary skill in the art readily appreciate, the web content that comprises the inventive client side software and/or web server content are typically stored on computer readable media at the client and/or server.

In accordance with another embodiment of the present invention, a mechanism is provided to load a web browser's cache outside of the web browser's runtime environment. In accordance with this embodiment, a separate, high performance application requests the web content, and loads it into the web browser's cache while leaving the web browser's cache in a state that is readable by the web browser. This embodiment of the present invention is useful for the following reason. A web browser typically attempts to display web content as it is being retrieved. Although this is useful for providing the user with an impression that something is happening, it delays the overall completion of the response. An external application, that operates in accordance with this embodiment of the present invention is advantageous because it can operate faster than the web browser since it does not have to spend any processing time on displaying content.

Features of Embodiment 6000 That Will Be Referred to Generally as IntenseSpeedSpiking

In accordance with one embodiment of the present invention, a seeding mechanism is provided by directing simulated Internet users to request web content, even though they do not need it themselves. When this is done, intervening caching servers in the Internet notice the web content as it is being requested and cache it. In accordance with this embodiment, the caching algorithm of caching servers in use (Inktomi for example) is determined, and simulated Internet users (geographically focused computers) are directed to make requests for this web content in a manner, and at a frequency, that will cause the caching servers to view the requested web content as popular. As a result, the caching servers will add the requested web content to its cached content database. Additional requests are made over time to continue tricking the caching servers into believing that the requested web content is popular, and that it should continue to be cached. As a result, reception of requested content is quicker when a real user requests the content.

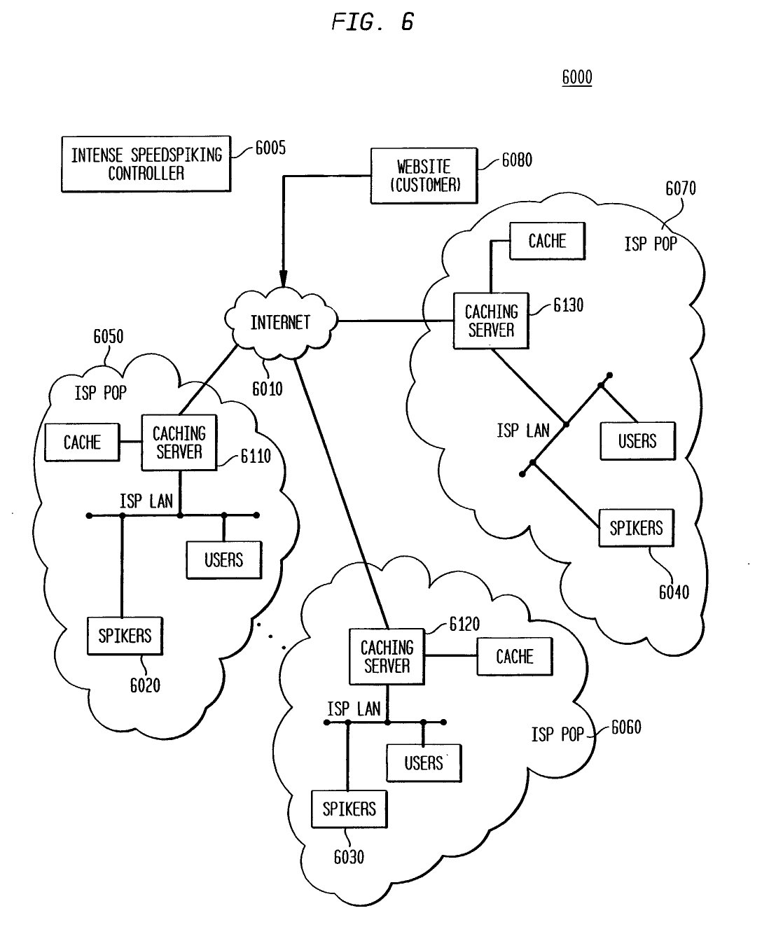

FIG. 6 shows a block diagram of a web site that is enhanced by embodiment 6000 of the present invention to provide the above-described feature; referred to below as IntenseSpeedSpiking. As shown in FIG. 6, IntenseSpeedSpiking Controller 6005 sends messages over Internet 6010 to one or more of spikers 6020, 6030, and 6040. As further shown in FIG. 6, spikers 6020, 6030, and 6040 are disposed at Internet Service Provider (“ISP”) Points of Presence (“POP”) 6050, 6060, and 6070, respectively. As still further shown in FIG. 6, a typical ISP POP comprises a caching server, a cache, and a spiker connected to an ISP LAN. In response to the messages received from IntenseSpeedSpiking Controller 6000, one or more of spikers 6020, 6030, and 6040 send requests for web content to customer web site 6080. In accordance with this embodiment, spikers 6020, 6030, and 6040 send such requests in a fashion and/or frequency (methods for determining such fashion and such frequency are well known to those of ordinary skill in the art) that one or more of caching servers 6110, 6120, and 6130 take notice, and cache the responses to the requests from spikers 6020, 6030, and 6040. Advantageously, in accordance with this embodiment of the present invention, users connected to the ISP POP which comprises spikers get a faster response when requesting web content.

Those skilled in the art will recognize that the foregoing description has been presented for the sake of illustration and description only. As such, it is not intended to be exhaustive or to limit the invention to the precise form disclosed.

What is claimed is:

1. A method for providing multimedia information wherein a first aspect is stored separately from a second aspect, which method comprises the steps of:
receiving a request for access to a first aspect of the multimedia information over a first communication medium; and
providing only the first aspect of the multimedia information over a second communication medium.

2. A method for providing multimedia information which comprises the steps of:
receiving a request for access to a first aspect of the multimedia information over a first communication medium;
providing the first aspect of the multimedia information over a second communication medium;
receiving a request for access to a second aspect of the multimedia information over the first communication medium; and
providing the second aspect of the multimedia information to the user over the first communication medium.

3. The method of claim 2 which further comprises the step of:
displaying the second aspect.

4. The method of claim 3 which further comprises the step of:
synchronizing the step of displaying the second aspect with the step of providing the first aspect.

5. The method of claim 4 wherein the second aspect is visual information and the first aspect is audio information.

6. The method of claim 5 wherein the step of synchronizing comprises displaying the second aspect a predetermined time after the step of providing the first aspect.

7. The method of claim 6 wherein the step of synchronizing includes receiving notification of the approximate start of the step of providing the first aspect.

8. An apparatus that enables access of multimedia information from a web site that includes a web server, which apparatus comprises:
a web server add-in component;
wherein the web server add-in component: (a) analyzes first requests related to access of a first aspect of the multimedia information, which first requests are received by the web server from a user over a first communication medium, and (b) directs information related to the first requests to a multimedia server;
wherein, the multimedia server, in response to the information related to the first requests, provides the first aspect of the multimedia information to the user over a second communication medium.

9. The apparatus of claim 8 further comprising a web page:
wherein the web server provides the web page to the user over the first communication medium;
wherein the web page comprises software or a pointer to software that causes second requests related to access of a second aspect of the multimedia information to be directed to the web server over the first communication medium; and
wherein the web server, in response to the second requests, provides the second aspect of the multimedia information to the user over the first communication medium.

10. The apparatus of claim 9 wherein the software further comprises notification information used to synchronize the first and second aspects of the multimedia information.

11. The apparatus of claim 10 wherein the notification information comprises a time index for the second aspect relative to a time at which the multimedia server begins to provide the first aspect.

12. The apparatus of claim 9 wherein the web server returns a message to the user that causes a user appliance or web browser that accesses the web page to continue without moving to another web page.

13. The apparatus of claim 9 wherein the first aspect is audio information and the second aspect is visual information.

14. The apparatus of claim 9 wherein the first communication medium is a data connection and the second communication medium is a telephone connection.

15. A computer readable medium encoded with a web page which enables access to multimedia information which web page comprises:
first software code, or a pointer to the first software code, that causes a web browser to request a first aspect of multimedia information over a first connection to a web server, the first aspect to be delivered over the first connection; and
second software code, or a pointer to the second software code, that causes the web browser to request a second aspect of the multimedia information over the first connection, the second aspect to be delivered over a second connection.

16. The computer readable medium of claim 15 wherein the web page further comprises:
synchronization information, or a pointer to the synchronization information; and
third software code, or a pointer to the third software code, that uses the synchronization to enable synchronization between display of the first and second aspects of the information.
